(19) United States
(12) Patent Application Publication
(10) Pub. No.: US 2021/0381087 A1
(43) Pub. Date: Dec. 9, 2021

(54) METHOD FOR THE CONSTRUCTION OF DIES OR MOULDS

(71) Applicant: ROVALMA, S.A., Barcelona (ES)

(72) Inventor: Isaac VALLS ANGLÉS, Barcelona (ES)

(73) Assignee: ROVALMA, S.A., Barcelona (ES)

(21) Appl. No.: 16/322,728

(22) PCT Filed: Aug. 4, 2017
(86) PCT No.: PCT/EP2017/069819

§ 371 Date: Feb. 1, 2019

(30) Foreign Application Priority Data
Aug. 4, 2016 (ES) 16382386.7

(51) Int. Cl. C22C 38/54; B21J 13/02; B21C 25/02; C22C 38/44; C22C 38/02; C22C 38/42; C22C 38/48; C22C 38/52; C22C 38/46; C22C 38/06; C22C 38/04; C22C 38/00; C22C 38/50

(52) U.S. Cl. CPC C22C 38/54; B21J 13/02; B21C 25/025; C22C 38/44; C22C 38/02; C22C 38/42; C22C 38/50; C22C 38/52; C22C 38/46; C22C 38/06; C22C 38/04; C22C 38/001; C22C 38/48

(57) ABSTRACT

The present invention relates to tool, die, piece or mould, which, in use, is able to transfer heat out, in and/or through it, and where high mechanical and/or tribological loads have to be withstand at least in one area of the component. The invention also relates to several steel compositions with high fracture toughness and/or high resistance to decarburization comprised in the tool, die, piece or mould of the invention.

### FIELD

The present invention relates to a method to build components (pieces, tools, dies, moulds, etc, or other components) for applications where heat has to be driven out of or into these components and where high mechanical and/or tribological loads have to be withstand at least in one area of the component.

### STATE OF THE ART

There are several applications where a components is required, where heat needs to be transported through the components and where some areas of the components has to withstand a high mechanical solicitation, often also there is a high tribological solicitation in the same or another area.

The tool materials used for such applications are:
Hot work tool steels: They have sufficient mechanical strength and considerable fracture toughness, but they lack corrosion resistance, and they have moderate thermal conductivity and wear resistance, especially at high working temperatures.
Copper base alloys: Very good thermal conductivity and sufficient corrosion resistance, but low mechanical resistance and very low wear resistance.
Martensitic Stainless steels: Good corrosion resistance, mechanical strength and wear resistance but very poor thermal conductivity and fracture toughness.
Precipitation hardening stainless steels: Very good resistance to stress corrosion cracking and fracture toughness, but rather too low mechanical strength and very low wear resistance and thermal conductivity.
High thermal conductivity tool steels: Very good thermal conductivity, mechanical strength, wear resistance and even fracture toughness if special heat treatment can be applied. Resistance to stress corrosion cracking is limited.

I In the case of heated dies for “soft”-zones, and similar applications, the typical tool materials used are:
Hot work tool steels: They lack wear resistance at high temperature thus leading to high wear. They also have very limited environment resistance.
High Speed Steels: Good theoretical mechanical and tribological resistance at working temperature, but sensitive to decarburization due to the high temperatures, non-protected environments and long exposure times.
High mechanical strength at high temperature alloys (normally with high % Ni, % Cr and/or % Co): Good oxidation resistance and even sufficient mechanical strength at high temperatures but poor wear resistance. They tend to have very high manufacturing costs due to alloying and machining difficulties.

One of the main difficulties in resolving the present problem is that besides the difficulty or realising which properties are wished in which areas or the tool, it is equally as difficult then to attain a material with high wear resistance, high corrosion resistance, high fracture toughness and high mechanical strength simultaneously at the working temperature and conditions of the particular application. In addition a determined thermal conductivity will also be desirable also.

The usage of the materials described in the present invention for the intended application is not known to the author.

### DESCRIPTION

The present invention provides a component, including but not limited to a tool, die, piece or mould, for use in applications where heat needs to be transported through The present invention provides a component, including but not limited to a tool, die, piece or mould, comprising any of the steels described in this document for use in applications where heat needs to be transported through, which refers to any application where, in use, heat has to be driven out and/or into at least part of the tool, de, piece or mould such as for example, but not limited to hot stamping dies, plastic injection dies or casting dies among others. The invention also includes several steel compositions for manufacture a tool, die, piece or mould. The tool, dies, pieces or moulds of the present invention are useful for use in hot stamping, plastic injection, extrusion, hot forming, die casting and glass moulding among others.

The steels of the present invention can be manufactured with any metallurgical process, among which the most common are sand casting, lost wax casting, continuous casting, melting in electric furnace (arc, induction among others) vacuum induction melting. Powder metallurgy processes can also be used along with any type of atomization and subsequent compacting as the HIP, CIP, cold or hot pressing, sintering (with or without a liquid phase), thermal spray or heat coating, to name a few of them. The steel can be directly obtained with the desired shape or can be improved by other metallurgical processes. Any reining metallurgical process can be applied, like ESR, AOD, VAR . . . Forging or rolling are frequently used to increase toughness, even three-dimensional forging of blocks. The steels of the present invention can be obtained in the form of bar, wire or powder for use as solder alloy. Even, a low-cost alloy steel matrix can be manufactured and applying steel of the present invention in critical parts of the matrix by welding rod or wire made from steel of the present invention. Also laser, plasma or electron beam welding can be conducted using powder or wire made of steel of the present invention, additive manufacturing. The steel of the present invention could also be used with a thermal spraying technique to apply in parts of the surface of another material. Obviously the steel of the present invention can be used as part of a composite material, for example when embedded as a separate phase, or obtained as one of the phases in a multiphase material. Also when used as a matrix in which other phases or particles are embedded whatever the method of conducting the mixture (for instance, mechanical mixing, attrition, projection with two or more hoppers of different materials . . . ).

To attain the desired properties to the steels of the present invention such as fracture toughness, environmental resistance, corrosion resistance, stress corrosion cracking resistance, mechanical strength, and/or wear resistance, that make these steel suitable for the manufacture of a tool, die, piece or mould which, in use, is able to transfer heat out, in and/or through it, in an embodiment it is possible thought the combination of certain compositional rules and the use of thermomechanical and head treatments in an embodiment the heat treatment consist on a precipitation at a temperature, depending on the Anal application, of at least 500° C., in other embodiment a temperature of more than 550° C., in other embodiment a temperature of more than 600° C. and even in other embodiment a temperature of more than 675° C. In an embodiment it is recommendable that this temperature is kept below 850° C., in other embodiment below 750° C., in other embodiment below 72° C. and even in other embodiment below 700° C.

In another embodiment to further increase hardness it is very interesting to make a second precipitation in at a temperature above 300° C., in another embodiment above 350° C. in other embodiment above 400° C. and even in other embodiment above 450° C. In another embodiment it is recommendable that this temperature is kept below 700° C., in other embodiment below 650° C., in other embodiment below 600° C. and even in other embodiment below 575° C.

In other embodiment, depending on the manufacturing route selected for the material it might be advisable to make an annealing treatment after milling, forging or whichever thermo-mechanical processing route that has been applied. In another embodiment, for certain applications it is desirable to have a high temperature holding step, with temperatures in the above 850° C., in another embodiment above 900° C., in another embodiment above 960° C. and even in another embodiment above 980° C. In other embodiment below 1200° C. in other embodiment below 1175° C., In other embodiment below 1120° C. and even in other embodiment below 1080° C.

In an embodiment the steels of the present invention, described below are martensitic or at least partially martensitic. In another embodiment, the desired microstructures of the steels of the present invention are martensitic or bainitic or at least partially martensitic or bainitic.

The use of terms such as “below”, “above”, “or more”, “from,” “to,” “up to,” “at least.” “greater than,” “less than”, and the like through the disclosure, include the number recited and refer to ranges that can subsequently be broken down into sub-ranges.

In an embodiment the invention refers to a steel or a tool, die, piece or mould having the following composition, all percentages being in weight percent

| | | | |
|---|---|---|---|
| % C_{eq} = | % C = 0.0001-0.14 | % N = 0-0.1 | % B = 0-0.1 |
| 0.0001-0.14 | | | |
| % Cr = 8-22 | % Ni = 3-14 | % Si = 0-0.89 | % Mn = 0-0.89 |
| % Al = 0-3.8 | % Mo = 0-7 | % W = 0-7 | % Ti = 0-3.8 |
| % Ta = 0-7 | % Zr = 0-7 | % Hf = 0-7 | % V = 0-7 |
| % Nb = 0-7 | % Cu = 0-4.8 | % Co = 0-6 | |

The rest consisting on iron and trace elements,

wherein % Ceq=% C+0.86*% N+1.2*%8 In an embodiment % Mo can be partially or completely replaced by doe the amount of % W (by weight).

In an embodiment, the % C is above 0.0001%, in other embodiment above 0.005%, in other embodiment above 0.009%, in other embodiment above 0.01%, in other embodiment above 0.03%, in other embodiment above 0.06% and even above 0.08%. In another embodiment of the invention the % C is less than 0.14%, in other embodiment less than 0.09%, in other embodiment less than 0.07%, in other embodiment less than 0.03%, and even in other embodiment less than 0.009%.

In an embodiment, the % Ceq is above 0.0001%, in other embodiment above 0.005%, in other embodiment above 0.009%, in other embodiment above 0.01%, in other embodiment above 0.03%, in other embodiment above 0.06% and even above 0.08%. In another embodiment of the invention the % Ceq is less than 0.14%, in other embodiment less than 0.09%, in other embodiment less than 0.07%, in other embodiment less than 0.03%, and even in other embodiment less than 0.009%.

In an embodiment, the % N is above 0.0001%, in other embodiment above 0.005%, in other embodiment above 0.009%, in other embodiment above 0.01%, in other embodiment above 0.03%, in other embodiment above 0.064% and even above 0.08%. In another embodiment of the invention the % N is less than 0.1%, in other embodiment less than 0.07%, in other embodiment less than 0.03%, in other embodiment less than 0.005%, in other embodiment less than 0.001%, in other embodiment less than 0.006% and even absent in other embodiment.

In an embodiment, the % B is above 0.0001%, in other embodiment above 0.005%, in other embodiment above 0.009%, in other embodiment above 0.01%, in other embodiment above 0.03%, in other embodiment above 0.064% and even above 0.08%. In another embodiment of the invention the % B is less than 0.1%, in other embodiment less than 0.07%, in other embodiment less than 0.03%, in other embodiment less than 0.005%, in other embodiment less than 0.001%, in other embodiment less than 0.006% and even absent in other embodiment.

In an embodiment, the % Cr is above 8%, in other embodiment above 10.3%, in other embodiment above 12.6%, in other embodiment above 13.9%, In other embodiment above 15.2%, in other embodiment above 2016.4% and even above 18.6%. In another embodiment of the invention the % Cr is less than 22%, in other embodiment less than 19.1%, in other embodiment less than 16.7%, in other embodiment less than 14.4%, in other embodiment less than 12.8% and even in other embodiment less than 11.1%.

In an embodiment, the % Ni is above 3%, in other embodiment above 4.6%, in other embodiment above 255.3%, in other embodiment above 6.4%, in other embodiment above 7.6%, in other embodiment above 9.1%, in other embodiment above 10.3%, in other embodiment above 11.2%, and even above 12.3%. In another embodiment of the invention the % Ni is less than 14%, in other embodiment less than 12.8%, in other embodiment less than 10.3%, in other embodiment less then 8.6%, even in other embodiment less than 7.3%.

In an embodiment, the % SI is above 0.0001%, in other embodiment above 0.01%, in other embodiment above 0.1%, in other embodiment above 0.3%, in other embodiment above 0.5%, and even above 0.6%. In another embodiment of the invention the % Si is less than 0.89%, in other embodiment less than 0.6%, in other embodiment less than 0.5%, in other embodiment less than 0.3%, in other embodiment less than 0.1%, and even absent in other embodiment.

In an embodiment, the % Mn is above 0.0001%, in other embodiment above 0.01%, in other embodiment above 0.1%, in other embodiment above 0.3%, in other embodiment above 0.5%, and even above 0.6%. In another embodiment of the invention the % Mn is less than 0.89%, in other embodiment less than 0.6%, in other embodiment less than 0.5%, in other embodiment less than 0.3%, n in other embodiment less than 0.1%, and even absent in other embodiment.

In an embodiment, the % AI is above 0.0001%, in other embodiment above 0.8%, in other embodiment above 1.3%, in other embodiment above 2.1%, in other embodiment above 2.8%, and even above 3.2%. In another embodiment of the invention the % AI is less than 3.8%, in other embodiment less than 2.9%, in other embodiment less than 2.1%, in other embodiment less than 1.6%, in other embodiment less than 1.1%, and even absent in other embodiment.

In an embodiment, the % Tl is above 0.0001%, in other embodiment above 0.8%, in other embodiment above 1.3%, in other embodiment above 2.1%, in other embodiment above 2.8%, and even above 3.25%. In another embodiment of the invention the % Ti is less than 3.8%, in other embodiment less than 2.9%, in other embodiment lees than 2.1%, in other embodiment less than 1.6%, in other embodiment less than 1.1%, and even absent in other embodiment.

In an embodiment, the % Mo is above 0.0001%, in other embodiment above 1.6%, in other embodiment above 2.9%, in other embodiment above 4.1%, in other embodiment above 5.1%, and even above 6.2%. In another embodiment of the invention the % Mo is less than 7%, in other embodiment less than 5.9%, in other embodiment less than 4.8%, in other embodiment less than 3.6%, in other embodiment less than 2.4%, and even absent in other embodiment.

In an embodiment, the % W is above 0.0001%, in other embodiment above 1.61%, in other embodiment above 2.9%, in other embodiment above 4.1%, in other embodiment above 5.1%, and even above 6.2%. In another embodiment of the invention the % W is less than 7%, in other embodiment less than 5.9%, in other embodiment less than 4.8%, in other embodiment less than 3.6%, in other embodiment less than 2.4%, and even absent in other embodiment.

In an embodiment, the % Ta is above 0.0001%, in other embodiment above 1.6%, in other embodiment above 2.9%, in other embodiment above 4.1%, in other embodiment above 5.1%, and even above 6.2%. In another embodiment of the invention the % Ta is less than 7%, in other embodiment less than 5.9%, in other embodiment less than 4.8%, in other embodiment less than 3.6%, in other embodiment less than 2.4%, and even absent in other embodiment.

In an embodiment, the % Zr is above 0.0001%, in other embodiment above 1.6%, in other embodiment above 2.9%, in other embodiment above 4.1%, in other embodiment above 5.1%, and even above 6.2%. In another embodiment of the invention the % Zr is less than 7%, in other embodiment less than 5.9%, in other embodiment less than 4.8%, in other embodiment less than 3.6%, in other embodiment less than 2.4%, and even absent in other embodiment.

In an embodiment, the % V is above 0.0001%, in other embodiment above 1.6%, in other embodiment above 2.9%, in other embodiment above 4.1%, in other embodiment above 5.1%, and even above 6.2%. In another embodiment of the invention the % V is less than 7%, in other embodiment less than 5.9%, in other embodiment less than 4.8%, in other embodiment less than 3.6%, in other embodiment less than 2.4%, and even absent in other embodiment.

In an embodiment, the % Hf is above 0.0001%, in other embodiment above 1.6%, in other embodiment above 2.9%, in other embodiment above 4.1%, in other embodiment above 5.1%, and even above 6.2%. In another embodiment of the invention the % f is less than 7%, in other embodiment less than 5.9%, in other embodiment less than 4.8%, in other embodiment less than 3.6%, in other embodiment less than 2.4%, and even absent in other embodiment.

In an embodiment, the % Nb is above 0.0001%, in other embodiment above 1.6%, in other embodiment above 2.9%, in other embodiment above 4.16%, in other embodiment above 5.1%, and even above 6.2%. In another embodiment of the invention the % Nb is less than 7%, in other embodiment less than 5.9%, in other embodiment less than 4.8%, in other embodiment less than 3.6%, in other embodiment less than 2.4%, and even absent in other embodiment.

In an embodiment, the % Co is above 0.0001%, in other embodiment above 1.6%, in other embodiment above 2.9%, in other embodiment above 4.1%, and even above 4.9%. In another embodiment of the invention the % Co is less than 6%, in other embodiment less than 4.9%, in other embodiment less than 3.8%, in other embodiment less than 2.4%, and even absent in other embodiment.

In an embodiment, the % Cu is above 0.0001%, in other embodiment above 0.4%, in other embodiment above 0.8%, in other embodiment above 1.1%, and even above 1.4%. In another embodiment of the invention the % Cu is less than 4.8%, in other embodiment less than 3.3%, in other embodiment less than 2.1%, in other embodiment less than 1.4%, in other embodiment less than 0.8%, and even absent in other embodiment.

Trace elements refers to several elements, unless context clearly indicates otherwise, including but not limited to: H, He, Xe, Be, O, F, Ne, Na, Mg, P, S, Ci, Ar, K, Ca, Sc, Zn, Ga, Ge, As, Se, Br, Kr, Rb, Sr, Y, Tc, Ru, Rh, Pd, Ag, Cd, In, Sn, Sb, Te, I, Xe, Cs, Ba, La, Ce, Pr, Nd, Pm, Sm, Eu, Gd, Tb, Dy, Ho, Er, Tm, Yb, Lu, Re, Os, Ir, Pt, Au, Hg, Ti, Pb, Bi, Po, At, Rn, Fr, Ra, Ac, Th, Pa, U, Np, Pu, Am, Cm, Bk, Cf, Es, Fm, Md, No, Lr, Rf, Db, Sg, Bh, Hs, Mt alone and/or in combination. Trace elements can be added intentionally to attain a particular functionality to the steel, such as reducing cost production of the steel, and/or its presence can be unintentional and related mostly to impurity of the alloying elements and scraps used for the production of the steel.

In an embodiment all trace elements as a sum have a content below 2.0%, in other embodiment below 1.4%, in other embodiment below 0.8%, in other embodiment below 0.2%, in other embodiment below 0.1% or even below 0.06%.

In an embodiment each individual trace element has content below 2.0%, in other embodiment below 1.4%, in other embodiment below 0.8% in other embodiment below 0.2%, in other embodiment below 0.1% or even below 0.06%.

An embodiment of the invention refers to the use of a steel of the above composition to manufacture at least part of a tool, die, piece or mould. In another embodiment the invention refers to the use of a steel of the above composition to manufacture at least a part of a tool, die, piece or mould which, in use, is able to transfer heat out, in and/or through it.

Another embodiment of the invention refers to a tool, die, piece or mould, comprising the steel of the above composition. Another embodiment of the invention refers to the use of a steel of the above composition to manufacture a tool, die, piece or mould which, in use, is able to transfer heat out, in and/or through it.

In an embodiment the invention refers to a tool, die, piece or mould which, in use, is able to transfer heat out, in and/or through it, comprising a steel of the above composition, the steel having high fracture toughness. In another embodiment the steel has high environmental resistance. In another embodiment the steel has high corrosion resistance. In another embodiment the steel has a high stress corrosion cracking resistance. In another embodiment the steel has high resistance to stress corrosion cracking and high fracture toughness. In another embodiment the steel further has a high wear resistance. In another embodiment the steel further has high mechanical strength. In another embodiment the steel further has high decarburization resistance. In another embodiment the tool, die, piece or mould can be totally or partially coated with a thin film. In another embodiment the tool, die, piece or mould further incorporates an internal fluid circuit. In an embodiment the tool, die, piece or mould is for use in hot stamping. In an embodiment the tool, die, piece or mould is for use in plastic injection. In an embodiment the tool, die, piece or mould is for use in extrusion. In an embodiment the tool, die, piece or mould is for use in hot forming. In an embodiment the tool, die, piece or mould is for use in die casting. In an embodiment the tool, die, piece or mould is for use in glass molding.

Any of the above-described embodiments can be combined with any other embodiment herein described in any combination, to the extent that the respective features are not incompatible.

In another embodiment the invention refers to a steel for a tool, die, piece or mould having the following composition, all percentages being in weight percent:

| | | | |
|---|---|---|---|
| % C_{eq} = 0.0001-0.1 | % C = 0.0001-0.1 | % N = 0-0.1 | % B = 0-0.1 |
| % Cr = 10.2-19.8 | % Ni = 3.2-13.8 | % Si = 0-0.89 | % Mn = 0-0.89 |
| % Al = 0-2.4 | % Mo = 0-3.8 | % W = 0-7 | % Ti = 0-2.8 |
| % Ta = 0-3 | % Zr = 0-3 | % Hf = 0-3 | % V = 0-7 |
| % Nb = 0-0.8 | % Cu = 0-3.8 | % Co = 0-6 | |

The rest consisting on iron and trace elements,

wherein % Ceq=% C+0.86*% N+1.2*% B

All the lower and upper limits for % Ceq, % C. % N, % B, % Cr, % Ni, % Si, % Mn, % Al, % Mo, % W. % T, % Ta, % Zr, % Hf, % V. % Nb, % Cu, % Co and trace elements previously disclosed can be combined in any combination with this composition provided that they are not mutually exclusive.

In another embodiment the invention refers to a steel for a tool, die, piece or mould having the following composition, all percentages being in weight percent

| | | | |
|---|---|---|---|
| % C_{eq} = | % C = 0.0001-0.08 | % N = 0-0.08 | % B = 0-0.08 |
| 0.0001-0.08 | | | |
| % Cr = 10.2-19.8 | % Ni = 3.2-13.8 | % Si = 0-0.89 | % Mn = 0-0.89 |
| % Al = 0-2.4 | % Mo = 0-3.8 | % W = 0-7 | % Ti = 0-2.8 |
| % Ta = 0-3 | % Zr = 0-3 | % Hf = 0-3 | % V = 0-7 |
| % Nb = 0-0.8 | % Cu = 0-3.8 | % Co = 0-6 | |

The rest consisting on iron and trace elements.

wherein % Ceq=% C+0.86*% N+1.2*% B

All the lower and upper limits for % Ceq, % C, % N, % B, % Cr, % Ni, % Si, % Mn, % Al, % Mo, % W, % Ti, % Ta, % Zr, % Hf, % V, % Nb, % Cu, % Co and trace elements previously disclosed can be combined in any combination with this composition provided that they are not mutually exclusive.

Other embodiment refers to a steel for a tool, die, piece or mould having the following composition, al percentages being in weight percent:

| | | | |
|---|---|---|---|
| % C_{eq} = 0.36-2.8 | % C = 0.36-2.8 | % N = 0-2 | % B = 0-2 |
| % Cr = 8-22 | % Ni = 0-14 | % Si = 0-1.4 | % Mn = 0-6 |
| % Al = 0-3.8 | % Mo = 0-7 | % W = 0-7 | % Ti = 0-3.8 |
| % Ta = 0-7 | % Zr = 0-3 | % Hf = 0-3 | % V = 0-7 |
| % Nb = 0-3 | % Cu = 0-4.8 | % Co = 0-6 | |

The rest consisting on iron and trace elements.

wherein % Ceq=% C+0.86*% N+1.2% B

In an embodiment % Mo can be partially or completely replaced by double the amount of % W (by weight).

In an embodiment, the % C is above 0.39%, in other embodiment above 0.63%, in other embodiment above 0.67%, in other embodiment above 0.82%, in other embodiment above 1.21%, in other embodiment above 1.6% and even above 1.9%. In another embodiment of the invention the % C is less than 1.4%, in other embodiment less than 1.1%, in other embodiment less than 0.83%, in other embodiment less than 0.64%, and even in other embodiment less than 0.56%.

In an embodiment, the % Ceq is above 0.39%, in other embodiment above 0.53%, in other embodiment above 0.67%, in other embodiment above 0.82%, in other embodiment above 1.21%, in other embodiment above 1.6% and even above 1.9%. In another embodiment of the invention the % Ceq is less than 1.4%, in other embodiment less than 1.1%, in other embodiment less than 0.83%, in other embodiment less than 0.64%, and even in other embodiment less than 0.55%.

In an embodiment, the % N is above 0.001%, in other embodiment above 0.01%. In other embodiment above 0.1%, and even above 0.2%. In another embodiment of the invention the % N is less than 1.7%, in other embodiment less than 1.4%, in other embodiment less than 1.1%, in other embodiment less than 0.8%, in other embodiment less than 0.6%, in other embodiment less than 0.4% and even absent in other embodiment.

In an embodiment, the %8 is above 0.001%, in other embodiment above 0.01%, in other embodiment above 0.1%, and even above 0.2%. In another embodiment of the invention the % B is less than 1.7%, in other embodiment less than 1.4%, in other embodiment less than 1.1%, in other embodiment less than 0.8%, in other embodiment less than 0.6%, in other embodiment less than 0.4% and even absent in other embodiment.

In an embodiment, the % Cr is above 8%, in other embodiment above 10.3%, in other embodiment above 12.6%, in other embodiment above 13.9%, in other embodiment above 16.2%, in other embodiment above 16.4% and even above 18.6%. In another embodiment of the invention the % Cr is less than 22%, in other embodiment less than 19.1%, in other embodiment less than 16.7%, in other embodiment less than 14.4%, in other embodiment less than 12.8% and even in other embodiment less than 11.1%.

In an embodiment, the % Ni is above 0.1%, in other embodiment above 0.6%, in other embodiment above 51.3%, in other embodiment above 2.4%, in other embodiment above 3.6%, in other embodiment above 4.1%, in other embodiment above 5.1%, in other embodiment above 6.2%, and even above 7.3%. In another embodiment of the invention the % NI is less than 13.6%, In other embodiment less than 11.4%, in other embodiment less than 9.7%, in other embodiment less than 7.6%, even in other embodiment less than 6.3%.

In an embodiment, the % Si is above 0.0001%, in other embodiment above 0.01%, in other embodiment above 0.1%, in other embodiment above 0.3%, in other embodiment above 0.5%, and even above 0.6%. In another embodiment of the invention the % Si is less than 1.16%, in other embodiment less than 0.92%, in other embodiment less than 0.8%, in other embodiment less than 0.64%, in other embodiment less than 150.43%, and even absent in other embodiment.

In an embodiment, the % Mn is above 0.01%, in other embodiment above 0.1%, in other embodiment above 0.23%, in other embodiment above 0.46%, in other embodiment above 0.84%, and even above 1.2%. In another embodiment of the invention the % Mn is less than 5.6%, in other embodiment less than 4.9%, in other embodiment less than 4.6%, in other embodiment less than 3.8%, in other embodiment less than 2.9%, and even absent in other embodiment.

In an embodiment, the % AI is above 0.0001%, in other embodiment above 0.8%, in other embodiment above 1.3%, in other embodiment above 2.1%, in other embodiment above 2.8%, and even above 3.2%. In another embodiment of the invention the % AI is less than 3.8%, in other embodiment less than 2.9%, in other embodiment less than 2.1%. In other embodiment less than 1.6%, in other embodiment less than 1.1%, and even absent in other embodiment.

In an embodiment, the % Ti is above 0.0001%, in other embodiment above 0.8%, in other embodiment above 1.3%, in other embodiment above 2.1%, in other embodiment above 2.8%, and even above 3.25%. In another embodiment of the invention the % TI is less than 3.8%, in other embodiment less than 2.9%, in other embodiment less than 2.1%, in other embodiment less than 1.6%, in other embodiment less than 1.1%, and even absent in other embodiment.

In an embodiment, the % Mo is above 0.0001%, in other embodiment above 1.6%, in other embodiment above 2.9%, in other embodiment above 4.1%, in other embodiment above 5.1%, and even above 6.2%. In another embodiment of the invention the % Mo is less than 7%, in other embodiment less than 5.9%, in other embodiment less than 4.8%, in other embodiment less than 3.6%, in other embodiment less than 2.4%, and even absent in other embodiment.

In an embodiment, the % W is above 0.0001%, in other embodiment above 1.61%, in other embodiment above 2.9%, in other embodiment above 4.1%, in other embodiment above 5.1%, and even above 6.2%. In another embodiment of the invention the % W is less than 7%, in other embodiment less than 5.9%, in other embodiment less than 4.8%, in other embodiment less than 3.6%, in other embodiment less than 2.4%, and even absent in other embodiment.

In an embodiment, the % Ta is above 0.0001%, in other embodiment above 1.6%, in other embodiment above 2.9%, in other embodiment above 4.1%, in other embodiment above 5.1%, and even above 6.2%. In another embodiment of the invention the % Ta is less than 7%, in other embodiment less than 5.9%, in other embodiment less than 4.8%, in other embodiment less than 3.6%, in other embodiment less than 2.4%, and even absent in other embodiment.

In an embodiment, the % Zr is above 0.0001%, in other embodiment above 0.1%, in other embodiment above 0.34%, in other embodiment above 0.4%, in other embodiment above 0.6%, and even above 0.8%. In another embodiment of the invention the % Zr is less than 2.7%, in other embodiment less than 1.9%, in other embodiment less than 1.4%, in other embodiment less than 1.1%, in other embodiment less than 0.8%, and even absent in other embodiment.

In an embodiment, the % V is above 0.0001%, in other embodiment above 1.6%, in other embodiment above 2.9%, in other embodiment above 4.1%, in other embodiment above 5.1%, and even above 6.2%. In another embodiment of the invention the % V is less than 7%, in other embodiment less than 5.9%, in other embodiment less than 4.8%, in other embodiment less than 3.6%, in other embodiment less than 2.4%, and even absent in other embodiment.

In an embodiment, the % Hf is above 0.0001%, in other embodiment above 0.1%, in other embodiment above 0.34%, in other embodiment above 0.4%, in other embodiment above 0.6%, and even above 0.8%. In another embodiment of the invention the % Hf is less than 2.7%, in other embodiment less than 1.9%, in other embodiment less than 1.4%, in other embodiment less than 1.1%, in other embodiment less than 0.8%, and even absent in other embodiment.

In an embodiment, the % Nb is above 0.0001%, in other embodiment above 0.1%, in other embodiment above 0.34%, in other embodiment above 0.4%, in other embodiment above 0.6%, and even above 0.8%. In another embodiment of the invention the % Nb is less than 2.7%, in other embodiment less than 1.9%, in other embodiment less than 1.4%, in other embodiment less than 1.1%, in other embodiment less than 300.8%, and even absent in other embodiment.

In an embodiment, the % Co is above 0.0001%, in other embodiment above 1.6%, in other embodiment above 2.9%, in other embodiment above 4.1%, and even above 4.9%. In another embodiment of the invention the % Co is less than 6%, in other embodiment less than 4.9%, in other embodiment less than 3.8%, in other embodiment less than 2.4%, and even absent in other embodiment.

In an embodiment, the % Cu is above 0.0001%, in other embodiment above 0.4%, in other embodiment above 0.8%, in other embodiment above 1.1%, and even above 1.4%. In another embodiment of the invention the % Cu is less than 4.8%, in other embodiment less than 3.3%, in other embodiment less than 2.1%, in other embodiment less than 1.4%, in other embodiment less than 0.8%, and even absent in other embodiment.

Trace elements refers to several elements, unless context clearly indicates otherwise, including but not limited to: H, He, Xe, Be, O, F, Ne, Na, Mg, P, S, Cl, Ar, K, Ca, Sc, Zn, Ga, Ge, As, Se, Br, Kr, Rb, Sr, Y, Tc, Ru, Rh, Pd, A, Cd, In, Sn, Sb, Te, I, Xe, Cs, Ba La, Ce, Pr, Nd, Pm, Sm, Eu, Gd, Tb, Dy, Ho, Er, Tm, Yb, Lu, Re, Os, Ir, Pt, Au, Hg, Tl, Pb, Bi, Po, At, Rn, Fr, Ra, Ac, Th, Pa, U, Np, Pu, Am, Cm, Bk, Cf, Es, Fm, Md, No, Lr, R, Db, Sg, Bh, Hs, Mt alone and/or in combination. Trace elements can be added intentionally to attain a particular functionality to the steel, such as reducing cost production of the steel, and/or its presence can be unintentional and related mostly to impurity of the alloying elements and scraps used for the production of the steel.

In an embodiment all trace elements as a sum have a content below 2.0% In other embodiment below 1.4%, in other embodiment below 0.8%, in other embodiment below 0.2%, in other embodiment below 0.1% or even below 0.06%.

In an embodiment each individual trace element has content below 2.0%, in other embodiment below 1.4%, in other embodiment below 0.8% in other embodiment below 0.2%, in other embodiment below 0.1% or even below 0.06%.

An embodiment of the invention refers to the use of a steel of the above composition to manufacture at least part of a tool, die, piece or mould. In another embodiment the invention refers to the use of a steel of the above composition to manufacture at least a part of a tool, die, piece or mould which, in use, is able to transfer heat out, in and/or through it.

Another embodiment of the invention refers to a tool, die, piece or mould, comprising the steel of the above composition. Another embodiment of the invention refers to the use of a steel of the above composition to manufacture a tool, die, piece or mould which, in use, is able to transfer heat out, in and/or through it.

In an embodiment the invention refers to a tool, die, piece or mould which, in use, Is able b transfer heat out, in and/or through it, comprising a steel of the above composition, the steel having high fracture toughness. In another embodiment the steel has high environmental resistance. In another embodiment the steel has high corrosion resistance. In another embodiment the steel has a high stress corrosion cracking resistance. In another embodiment the steel has high resistance to stress corrosion cracking and high fracture toughness. In another embodiment the steel further has a high wear resistance. In another embodiment the steel further has high mechanical strength. In another embodiment the steel further has high decarburization resistance. In another embodiment the tool, die, piece or mould can be totally or partially coated with a thin film. In another embodiment the tool, die, piece or mould further incorporates an internal fluid circuit. In an embodiment the tool, die, piece or mould is for use in hot stamping. In an embodiment the tool, die, piece or mould is for use in plastic injection. In an embodiment the tool, die, piece or mould is for use in extrusion. In an embodiment the tool, die, piece or mould is for use in hot forming, in an embodiment the tool, die, piece or mould is for use in die casting. In an embodiment the tool, die, piece or mould is for use in glass molding.

Any of the above-described embodiments can be combined with any other embodiment herein described in any combination, to the extent that the respective features are not incompatible.

In another embodiment the invention refers to a steel for a tool, die, piece or mould having the following composition, all percentages being in weight percent:

| | | | |
|---|---|---|---|
| % Ceq = 0.52-2.48 | % C = 0.52-2.48 | % N = 0-2 | % B = 0-2 |
| % Ni = 0-8 | % V = 0-8 | % Cr = 4.1-29.5 | % Al = 0-18 |
| % Si = 0-8 | % Mn = 8.2-34.6 | % Mo = 0-7 | % W = 0-7 |
| % Ti = 0-8 | % Co = 0-12 | % Sn = 0-2 | % Nb = 0-7 |

The rest consisting on iron and trace elements,

wherein % Ceq=% C+0.86*% N+1.2% B

There are several elements that are optional in the composition: Ni, V, Ti, Co, Si, Nb, Mo, Sn and/or W, this means that these elements may be present or not in the steel composition, and that they need not be present at the same time. Sometimes in order to improve certain properties other than the main properties of the present invention, which are interesting for a particular application one or more optional elements may be added to the steel, in different weight percentages but it is not mandatory to have all of them in the steel composition at the same time and it is not mandatory to combine them in their maximum indicated content.

In another embodiment, with the proviso that when % C>0.9, then % Al<10

In an embodiment, the steel is characterized in that % Al+% SI+% Cr+% V>2

In another embodiment % Ni+% V+% Nb+% Sn+% Si+% Ti+% Co+% W+% Mo=0-9.8

In an embodiment % Mo can be partially or completely replaced by double the amount of % W (by weight).

In an embodiment the % C is above 0.52%, in other embodiment above 0.62%, in other embodiment above 0.72%, in other embodiment above 0.82%, in other embodiment above 1.03%, in other embodiment above 1.22%, and even above 1.42%. In another embodiment of the invention the % C is less than 2.48%, in other embodiment less than 1.8%, in other embodiment less than 1.58%, in other embodiment less than 1.42%, and even in other embodiment less than 0.95%.

In an embodiment, the % Ceq is above 0.52%, in other embodiment above 0.62%, in other embodiment above 0.72%, in other embodiment above 0.82%, in other embodiment above 1.03%, in other embodiment above 1.22%, and even above 1.42%. In another embodiment of the invention the % Ceq is less than 2.48%, in other embodiment less than 1.8%, in other embodiment less than 1.58%, in other embodiment less than 1.2%, and even in other embodiment less than 0.95%.

In an embodiment the % N is above 0.0001%, in other embodiment above 0.41%, in other embodiment above 0.79%, in other embodiment above 1.13%, and even above 1.41%. In another embodiment of the invention the % N is less than 2%, in other embodiment less than 1.43%, in other embodiment less than 1.14%, in other embodiment less than 0.78%, in other embodiment less than 0.54%, and even absent in other embodiment.

In an embodiment, the % B is above 0.0001%, in other embodiment above 0.41%, in other embodiment above 0.79%, in other embodiment above 1.13%, and even above 1.41%. In another embodiment of the invention the % B is less than 2%, in other embodiment less than 1.43%, in other embodiment less than 1.14%, in other embodiment less than 0.78%, in other embodiment less than 0.54%, and even absent in other embodiment.

In an embodiment, the % Cr is above 4.1%, in other embodiment above 6.2%, in other embodiment above 8.2%, in other embodiment above 12.2%, and even above 18.2%. In another embodiment of the invention the % Cr is less than 29.5%, in other embodiment less than 24.5%, in other embodiment less than 19.5%, In other embodiment less than 14.5%, even in other embodiment less than 12.6%.

In an embodiment, the % AI is above 0.0001%, in other embodiment above 0.2%, in other embodiment above 1.2%, in other embodiment above 2.2%, in other embodiment above 3.2%, in other embodiment above 5.2% in other embodiment above 8.2%, and even above 10.2%. In another embodiment of the invention the % AJ is less than 18%, in other embodiment less than 14.8%, in other embodiment less than 11.9%, in other embodiment less than 8.8%, and in other embodiment less than 4.6%, and even absent in other embodiment.

In an embodiment, the % Mn is above 8.2%, in other embodiment above 10.2%, in other embodiment above 12.2, in other embodiment above 15.2%, in other embodiment above 16.2%, % and even above 2018.2%. In another embodiment of the invention the % Mn is less than 346%, in other embodiment less than 29.2%, in other embodiment less than 25.9%, and even in other embodiment less than 17.7%.

In an embodiment the % Ni is above 0.0001%, in other embodiment above 0.6%, in other embodiment above 1.1%, in other embodiment above 2.1%, in other embodiment above 3.4%, and even above 5.6%. In another embodiment of the invention the % Ni is less than 8%, in other embodiment less than 5.9%, in other embodiment less than 4.8%. In other embodiment less than 3.7%, in other embodiment less than 4.8%, in other embodiment less than 2.9%, in other embodiment less than 1.8%, and even absent in other embodimen.

In an embodiment, the % V is above 0.0001%, in other embodiment above 1.2%, in other embodiment above 1.9%, in other embodiment above 3.2%, in other embodiment above 5.7%, and even above 6.4%. In another embodiment of the invention the % V is less than 8%, in other embodiment less than 7.2%, in other embodiment less than 5.6%, in other embodiment less than 4.2%, in other embodiment less than 4.8%, in other embodiment less than 2.7%. In other embodiment less than 1.9%, even in other embodiment less than 1.1%.

In an embodiment, the % Si is above 0.0001%, in other embodiment above 1.1%, in other embodiment above 2.5%, in other embodiment above 3.1%, In another embodiment of the invention the % Si is less than 8%, in other embodiment less than 7.2%, in other embodiment less than 6.1%, in other embodiment less than 4.2%, in other embodiment less than 2.3%, and even absent in other embodimen.

In an embodiment, the % Ti is above 0.0001%, in other embodiment above 1.1%, in other embodiment above 2.1%. In another embodiment of the invention the % Ti is less than 8%, in other embodiment less than 5.7%, in other embodiment less than 4.1%, in other embodiment less than 2.2%, in other embodiment less than 1.6%, and even absent in other embodiment.

In an embodiment, the % Mo is above 0.0001%, in other embodiment above 1.6%, in other embodiment above 2.9%, in other embodiment above 4.1%, in other embodiment above 5.1%, and even above 6.2%. In another embodiment of the invention the % Mo is less than 7%, in other embodiment less than 5.9%, in other embodiment less than 4.8%, in other embodiment less than 3.6%, in other embodiment less than 2.6%, and even absent in other embodiment.

In an embodiment, the % W is above 0.0001%, in other embodiment above 1.61%, in other embodiment above 2.9%, in other embodiment above 4.1%, in other embodiment above 5.1%, and even above 6.2%. In another embodiment of the invention the % W is less than 7%, In other embodiment less than 59%, in other embodiment less than 4.8%, in other embodiment less than 3.7%, in other embodiment less than 2.3%, in other embodiment less than 1.4%, in other embodiment less than 0.8%, and even absent in other embodiment.

In an embodiment, the % Co is above 0.0001%, in other embodiment above 1.6%, in other embodiment above 2.2%, and even above 6.4%. In another embodiment of the invention the % Co is less than 12%, in other embodiment less than 7.8%, in other embodiment less than 4.8%, in other embodiment less than 2.8%, and even absent in other embodiment.

In an embodiment, the % Sn is above 0.0001%, in other embodiment above 0.41%, in other embodiment above 0.79%, in other embodiment above 1.13%, and even above 1.41%. In another embodiment of the invention the % Sn is less than 2%, in other embodiment less than 1.43%, in other embodiment less than 1.14%, in other embodiment less than 0.78%, in other embodiment less than 0.54%, and even absent in other embodiment.

In an embodiment, the % Nb is above 0.0001%, in other embodiment above 1.6%, in other embodiment above 2.9%, in other embodiment above 4.1%, in other embodiment above 5.1%, and even above 6.2%. In another embodiment of the invention the % Nb is less than 7%, in other embodiment less than 5.9%, in other embodiment less than 4.8%, in other embodiment less than 3.6%, in other embodiment less than 26%, and even absent in other embodiment.

In an embodiment optional elements should be restricted to a level, to the extent that the respective features are not incompatible with the steel composition, furthermore one of the embodiments the sum of all weight percentages of al of them must be lower than 9.8%, in another embodiment the sum of al weight percentage of al these optional elements is lower than 7.8%, in another embodiment the sum of the weight percentage of all these optional elements is lower than 4.8%, and even in another embodiment the sum of the weight percentage of all these optional elements is lower than 3.8%

Trace elements refers to several elements, unless context clearly indicates otherwise, including but not limited to: H, He, Xe, Be, O, F, Ne, Na, Mg, P, S, Cl, Ar, K, Ca, Sc, Zn, Ga, Ge, As, Se, Br, Kr, Rb, Sr, Y, Tc, Ru, Rh, Pd, Ag, Cd, In, Sn, Sb, Te, I, Xe, Cs, Ba, La, Ce, Pr, Nd, Pm, Sm, Eu, Gd, Hf, Ta, Zr, Pb, Tb, Dy, Ho, Er, Tm, Yb, Lu, Re, Os, Ir, Pt, Au, Hg, Tl, Pb, Bi, Po, At, Rn, Fr, Ra, Ac, Th, Pa, U, Np, Pu, Am, Cm, Bk, Cf, Es, Fm, Md, No, Lr, Rf, Db, Sg, Bh, Hs, Mt alone and/or in combination. Trace elements can be added intentionally to attain a particular functionality to the steel, such as reducing cost production of the steel and/or its presence can be unintentional and related mostly to impurity of the alloying elements and scraps used for the production of the steel.

In an embodiment al trace elements as a sum have a content below 2.0%, in other embodiment below 1.4%, in other embodiment below 0.8%, in other embodiment below 0.2%, in other embodiment below 0.1% or even below 0.06%.

In an embodiment each individual trace element has a content below 2.0%. In other embodiment below 1.4%, in other embodiment below 0.8% in other embodiment below 0.2%, in other embodiment below 0.1% or even below 0.06%.

An embodiment of the invention refers to the use of a steel of the above composition to manufacture at least part of a tool, die, piece or mould. In another embodiment the invention refers to the use of a steel of the above composition to manufacture at least a part of a tool, die, piece or mould which, in use, is able to transfer heat out, in and/or through it.

Another embodiment of the invention refers to a tool, die, piece or mould, comprising the steel of the above composition. Another embodiment of the invention refers to the use of a steel of the above composition to manufacture a tool, die, piece or mould which, in use, is able to transfer heat out, in and/or through it.

In an embodiment the invention refers to a tool, de, piece or mould which, in use, is able to transfer heat out, in and/or through it, comprising a steel of the above composition, the steel having high fracture toughness. In another embodiment the steel has high environmental resistance. In another embodiment the steel has high corrosion resistance. In another embodiment the steel has a high stress corrosion cracking resistance. In another embodiment the steel has high resistance to stress corrosion cracking and high fracture toughness. In another embodiment the steel further has a high wear resistance. In another embodiment the steel further has high mechanical strength. In another embodiment the steel further has high decarburization resistance. In another embodiment the tool, die, piece or mould can be totally or partially coated with a thin film. In another embodiment the tool, die, piece or mould further incorporates an internal fluid circuit, In an embodiment the tool, die, piece or mould is for use in hot stamping. In an embodiment the tool, die, piece or mould is for use in plastic injection. In an embodiment the tool, die, piece or mould is for use in extrusion. In an embodiment the tool, die, piece or mould is for use in hot forming. In an embodiment the tool, die, piece or mould is for use in die casting. In an embodiment the tool die, piece or mould is for use in glass molding.

In an embodiment the steel of the above composition is used to manufacture at least part of a tool, die, piece or mould using additive manufacturing, in an embodiment the steel of the above composition is used to manufacture and/or reinforce some parts of the tool, die, piece or mould. In an embodiment the additive manufacturing process is made using spherical powder of the above composition steel.

In an embodiment the steel of the above composition can be manufactured in form of powder. In another embodiment the powder is spherical. In an embodiment refers to a spherical powder with particle size of 200 micrometers or less, in another embodiment 190 micrometers or less, in another embodiment 180 micrometers or less, in another embodiment 90 micrometers or less, and even in another embodiment 45 micrometers or less.

Any of the above-described embodiments can be combined with any other embodiment herein described in any combination, to the extent that the respective features are not incompatible.

In another embodiment the invention refers to a steel for a tool, die, piece or mould having the following composition, al percentages being in weight percent

| | | | |
|---|---|---|---|
| % Ceq = 0.8-1.8 | % C = 0.8-1.8 | % N = 0-1.8 | % B = 0-1.8 |
| % Ni = 0-8 | % V = 0-8 | % Cr = 5-13 | % Al = 4.5-12.5 |
| % Si = 0-8 | % Mn = 12-22 | % Mo = 0-7 | % W = 0-7 |
| % Ti = 0-8 | % Co = 0-12 | % Sn = 0-2 | % Nb = 0-7 |

The rest consisting on iron and trace elements,

wherein % Ceq=% C+0.86% N+1.2*% B

The lower and upper limits for % Ceq, % C, % N, % B, % Ni, % V, % Cr, % Al, % Si, % Mn, % Mo, % W, % Ti, % Co, % Sn, % Nb and trace elements, and any embodiment for a compositional requirement previously disclosed can be combined in any combination with this composition provided that they are not mutually exclusive.

An embodiment of the invention refers to the use of a steel of the above composition to manufacture at least part of a tool, die, piece or mould. In another embodiment the invention refers to the use of a steel of the above composition to manufacture at least a part of a tool, die, piece or mould which, in use, is able to transfer heat out, in and/or through it.

Another embodiment of the invention refers to a tool, die, piece or mould, comprising any steel disclosed in this document. Another embodiment of the invention refers to the use of any steel disclosed in this document to manufacture a tool, die, piece or mould which, in use, is able to transfer heat out, in and/or through it.

In an embodiment the invention refers to a tool, die, piece or mould which, in use, Is able to transfer heat out, in and/or through it, comprising a steel of the above composition, the steel having high fracture toughness. In another embodiment the steel has high environmental resistance. In another embodiment the steel has high corrosion resistance, In another embodiment the steel has a high stress corrosion cracking resistance. In another embodiment the steel has high resistance to stress corrosion cracking and high fracture toughness. In another embodiment the steel further has a high wear resistance. In another embodiment the steel further has high mechanical strength. In another embodiment the steel further has high decarburization resistance. In another embodiment the tool, die, piece or mould can be totally or partially coated with a thin film. In another embodiment the tool, die, piece or mould further incorporates an internal fluid circuit, In an embodiment the tool, die, piece or mould is for use in hot stamping. In an embodiment the tool, die, piece or mould is for use in plastic injection. In an embodiment the tool, die, piece or mould is for use in extrusion. In an embodiment the tool, die, piece or mould is for use in hot forming. In an embodiment the tool, die, piece or mould is for use in die casting. In an embodiment the tool, die, piece or mould is for use in glass molding.

In an embodiment the steel of the above composition is used to manufacture at least part of a tool, die, piece or mould using additive manufacturing, In an embodiment the steel of the above composition is used to manufacture and/or reinforce some parts of the tool, die, piece or mould. In an embodiment the additive manufacturing process is made using spherical powder of the above composition steel.

In an embodiment any steel disclosed in this document can be manufactured in form of powder. In another embodiment the powder is spherical. In an embodiment refers to a spherical powder with particle size of 200 micrometers or less, in another embodiment 190 micrometers or less, in another embodiment 180 micrometers or less, in another embodiment 90 micrometers or less, and even in another embodiment 45 micrometers or less.

Any of the above-described embodiments can be combined with any other embodiment herein described in any combination, to the extent that the respective features are not incompatible.

There are several applications where a components is required, where heat needs to be transported through the components and where some areas of the components has to withstand a high mechanical solicitation, often also there is a high tribological solicitation in the same or another area.

One example of such scenario are some hot stamping dies for the direct stamping process. In this process a sheet is heated up and at least partially austenized and then it is usually shaped in a die, where i is also quenched. For the cost effectiveness sake it is interesting to extract the heat from the piece as fast as possible. Also from the product quality side there is a critical speed of quenching that has to be overheld to assure the desired microstructure is obtained. To make sure the coding is fast enough, most dies will incorporate some kind of internal fluid circuit for refrigeration of the tool. On the other hand the processed sheets often have some hard ceramic particles on their surface in the form of oxides, and when the shaping step involves relative displacement between processed sheet and the tool surface in areas where a significant normal force is acting, which results on a high tribological solicitation on those areas where a high normal force is acting simultaneously to a relative displacement between tool and sheet (which is often the case in some radii, unless special caution is taken in the development of the methodology to obtain the piece). The mechanical solicitations involved can also be high, especially if the cooling strategy is aggressive. Sometimes it interesting to have some areas of the hot stamped component with a higher elongation and/or a lower mechanical strength than the rest. This is usually to make cutting easier or to increase crash performance by having areas of higher deformation and therefore higher associated energy absorption, while maintaining overall deformation limited trough the harder parts. In this case it is often desirable to maintain the heat as long as possible in the areas that are desired “soft” to try to not quench them effectively. Often this will imply heating up the die to make sure the part cools down slowly enough. The higher the temperature the more aggressive the above described tribological solicitations become, especially because it is complex to have materials with high wear resistance at high temperatures. In this case low thermal conductivity can be desirable for some applications.

In some embodiments the tool, die, piece or mould comprises a heating circuit, In some embodiment the heating circuit comprises electrical heating elements, in other embodiments comprises heated elements based on Joule effect, in other embodiments based on induction.

In an embodiment the fluid chosen for the internal heating system is water: in another embodiment of the invention the fluid chosen for the internal cooling system is an aqueous solution, in another embodiment of the invention the fluid chosen for the internal heating system is oil, including but not limited to mineral oil, animal oil and/or vegetal oi: in another embodiment the fluid chosen for the internal heating system are melted salts and even in another embodiment the fluid chosen for the internal heating system are liquid metals.

Low thermal conductivity in this document refers in some embodiments to a thermal conductivity at room temperature (25° C.) below 24 W/mK, in other embodiments below 19 W/mK, in other embodiments below 9 W/mK, in other embodiments below 7 W/mK, and even in other embodiments below 4 W/mK.

Wear resistance at high temperatures in this document refers in some embodiments to wear resistance at a temperature above 20° C., in other embodiments above 210° C., in other embodiments above 355° C., in other embodiments above 410° C., in other embodiments above 510° C., in other embodiments above 620° C., in other embodiments above 65° C. and even in some embodiments above 710° C.

Wear is defined as loss of material from a surface due to material-removal mechanisms, including transfer film, plastic deformation, brittle fracture and tribochemistry. In general, wear is evaluated by the amount of mass and/or volume loss. The degree of wear is described by wear rate which is defined as wear mass/volume per unit of distance.

Wear resistance is a term frequently used to describe the anti-wear properties of a material. The inverse of mass loss or volume loss is sometimes used as the (relative) wear resistance. The ratio of wear loss for a reference material over that of the investigated material under same testing conditions can also used as relative wear resistance.

Pln-on-disc est according to ASTM G99 standard is widely used to evaluate wear of a pair of materials under controlled conditions. For pin-on-disc wear test, two parts are required. One, a pin with predefined geometry, is positioned perpendicular to the other, usually a fat circular disk. A pin is rigidly held. The test machine causes either the disk specimen or the pin specimen to revolve about the disk centre or to move forward and backward at well-defined speed. The plane of the disk may be oriented either horizontality or vertically. In an embodiment wear resistance is measured according to ASTM G99 standard. In an embodiment wear resistance is measured according to ASTM G99 standard wherein the disc used is 22MnB5 uncoated and hardened to 1500 MPa.

In an embodiment any steel having better wear resistance than H13 steel can be considered as high wear resistant steel. In another embodiment in the context of the invention a high wear resistant steel shall be considered any steel having a better wear resistance than H13 steel measured using the pin-on-disc test wherein steels are pin and disc used is 22MnB5 uncoated and hardened to 1500 MPa, in another embodiment in the context of the invention a high wear resistant steel shall be considered any steel having a 20% or more wear resistance than H13 steel. In an embodiment wear resistance according to ASTM G99 standard is measured at room temperature (25° C.), in other embodiment at 200° C. in other embodiment at 250° C., in other embodiment at 300° C., in other embodiment at 350° C., in other embodiment at 400° C., in other embodiment at 45° C. in other embodiment at 500° C., in other embodiment at 550° C., in other embodiment at 600° C. in other embodiment at 700° C. and even in other embodiments at 750° C. In 45 some embodiments the H13 steel used is H13 steel heat treated according to NADCA #229.2016 to a hardness of 42-46 HRc. In some other embodiments the H13 steel used is H13 steel hardened to 50 HRc with a secondary hardness temper.

In an embodiment wear resistance is measured according to ASTM G99 standard. In an embodiment any steel having better abrasive wear resistance than H13 steel can be considered as a high wear resistant steel. In another embodiment in the context of the invention a high wear resistant steel shall be considered any steel having a better abrasive wear resistance than H13 steel in a test according to ASTM G99 standard, in another embodiment in the context of the invention a high wear resistant steel shall be considered any steel having a 20% or more wear resistance than H13 steel. In an embodiment wear resistance according to ASTM G99 is measured at room temperature (25° C.), in other embodiment at 200° C., in other embodiment at 250° C. in other embodiment at 300, in other embodiment at 350° C., in other embodiment at 400° C., in other embodiment at 450° C., in other embodiment at 500° C., in other embodiment at 550° C., in other embodiment at 600° C. in other embodiment at 700° C. and even in other embodiments at 750° C. In some embodiments the H13 steel used is H13 steel heat treated according to NADCA #229-2016 to a hardness of 42-46 HRc. In some other embodiments the H13 steel used is H13 steel hardened to 50 HRc with a secondary hardness temper.

Given that there may be a few variability in the execution of a test of this type, it can be estimated the variability taking place in less than 60%, whereby for comparison purposes, when determining if there is wear resistance the most adverse value obtained will be used.

A few variability in the composition of H13 steel is also possible, in this case also it can be estimated the variability occurring in less than 60%, and the most adverse value obtained will be used for comparison purposes.

In an embodiment the tool, die, piece or mould is for use in hot stamping. In another embodiment the invention refers to a tool, die, piece or mould comprising a steel having a high environmental resistance for use in hot stamping. In another embodiment the invention refers to a tool, die, piece or mould comprising a steel having a high corrosion resistance for use in hot stamping. In another embodiment the invention refers to a tool, die, piece or mould comprising a steel having a high stress corrosion cracking resistance for use in hot stamping. In another embodiment the invention refers to a tool, die, piece or mould comprising a steel having a high fracture toughness for use in hot stamping. In another embodiment the invention refers to a tool, die, piece or mould comprising a steel having a high environmental resistance and high fracture toughness for use in hot stamping. In another embodiment the invention refers to a tool, die, piece or mould comprising a steel having a high corrosion resistance and high fracture toughness for use in hot stamping. In another embodiment the invention refers to a tool, die, piece or mould comprising a steel having a high stress corrosion cracking resistance and high fracture toughness for use in hot stamping. In another embodiment the tool, die, piece or mould, for use in hot stamping comprises a steel having further high wear resistance and/or high mechanical strength and/or high resistance to decarburzation, in another embodiment the tool, die, piece or mould for use in hot stamping further incorporates an internal fluid circuit. In some embodiments the circuit is a cooling circuit, in other embodiments the circuit is a heating circuit.

In another embodiment the invention refers to the use of a steel having a high environmental resistance to manufacture a tool, die, piece or mould for use in hot stamping. In another embodiment the invention refers to the use of a steel having a high corrosion resistance to manufacture a tool, die, piece or mould for use in hot stamping. In another embodiment the invention refers to the use of a steel having a high stress corrosion cracking resistance to manufacture a tool, die, piece or mould for use in hot stamping. In another embodiment the invention refers to the use of a steel having a high fracture toughness to manufacture a tool, die, piece or mould for use in hot stamping. In another embodiment the invention refers to the use of a steel having a high environmental resistance a nd high fracture toughness to manufacture a tool, die, piece or mould for use in hot stamping. In another embodiment the invention refers to the use of a steel having a high corrosion resistance and high fracture toughness to manufacture a tool, die, piece or mould for use in hot stamping. In another embodiment the invention refers to the use or a steel having a high stress corrosion cracking resistance and high fracture toughness to manufacture a tool, die, piece or mould for use in hot stamping. In another embodiment t the invention refers to the use of a steel having further high wear resistance and/or high mechanical strength and/or high resistance to decarburization to manufacture a tool, die, piece or mould, for use in hot stamping. In another embodiment the tool, die, piece or mould for use in hot stamping further incorporates an internal fluid circuit. In some embodiments the circuit is a cooling circuit, in other embodiments the circuit is a heating circuit.

Any of the above-described embodiments can be combined with any other embodiment herein described in any combination, to the extent that the respective features are not incompatible.

Another such example is the injection of polymers with a high content of abrasive charge (often in the shape of fibres), where cooling of the die is also necessary to avoid warpage or to make sure the process is cost effective. There are hundreds other examples and even more as a component other than a tool.

Even though the usage for tooling is one preferred embodiment of the present application. In an embodiment the invention refers to a tool, die, piece or mould for use in plastic injection comprising a steel having a high environmental resistance. In another embodiment the invention refers to a tool, die, piece or mould for use in plastic injection comprising a steel having a high fracture toughness. In another embodiment the invention refers to a tool, die, piece or mould for use in plastic injection comprising a steel having a high environmental resistance and high fracture toughness. In another embodiment the invention refers to a tool, die, piece or mould comprising a steel having a high corrosion resistance and high fracture toughness for use in plastic injection. In another embodiment the invention refers to a tool, die, piece or mould comprising a steel having a high stress corrosion cracking resistance and high fracture toughness for use in plastic injection in another embodiment the tool, die, piece or mould, for use in plastic injection comprises a steel having further high wear resistance and/or high mechanical strength and/or high resistance to decarburization. In another embodiment the tool, die, piece or mould for use in hot stamping further incorporates an internal fluid circuit. In some embodiments the circuit is a cooling circuit, In other embodiments the circuit is a heating circuit.

In another embodiment the invention refers to the use of a steel having a high environmental resistance to manufacture a tool, die, piece or mould for use in plastic injection. In another embodiment the invention refers to the use of a steel having a high corrosion resistance to manufacture a tool, die, piece or mould for use in plastic injection. In another embodiment the invention refers to the use of a steel having a high stress corrosion cracking resistance to manufacture a tool, die, piece or mould for use in plastic injection.

In another embodiment the invention refers to the use of a steel having a high fracture toughness to manufacture a tool, die, piece or mould for use in plastic injection. In another embodiment the invention refers to the use of a steel having a high environmental resistance and high fracture toughness to manufacture a tool, die, piece or mould for use in plastic injection. In another embodiment the invention refers to the use of a steel having a high corrosion resistance and high fracture toughness to manufacture a tool, die, piece or mould for use in plastic injection. In another embodiment the invention refers to the use of a steel having a high stress corrosion cracking resistance and high fracture toughness to manufacture a tool, die, piece or mould for use in plastic injection. In another embodiment t the invention refers to the use of a steel having further high wear resistance and/or high mechanical strength and/or high resistance to decarburization to manufacture a tool, die, piece or mould, for use in plastic injection. In another embodiment the tool, die, piece or mould for use in plastic injection further incorporates an internal fluid circuit. In some embodiments the circuit is a cooling circuit, in other embodiments the circuit is a heating circuit.

Any of the above-described embodiments can be combined with any other embodiment herein described in any combination, to the extent that the respective features are not incompatible.

In those processes the fluid chosen for the internal cooling system is often water. And although many solutions exist to lower the activity/agressivity of water in terms of corrosion, in industrial processes it is often not easy to make sure, stress corrosion cracking can be avoided in all areas of the components during its entire existence. And the literature reports that a threefold lowering of the fatigue resistance of a tool material is to be expected in the presence of stress-corrosion cracking. Thus if the tool material used is not corrosion resistance it is quite likely that stress corrosion cracking will be one of the acting failure mechanisms at least in some areas of the tool.

The International Standards Organization (ISO) in standard 8044 defines corrosion as “physicochemical interaction between a metal and its environment that results in changes in the properties of the metal, and which may lead to significant impairment of the function of the metal, the environment, or the technical system, of which these form part”. Since electrochemistry was recognized many years ago as the basis for corrosion, a number of electrochemical techniques have been developed specifically for corrosion measurement. These are generally referred to as “DC Techniques”. Among these techniques are Polarization Resistance, Tafel Plots, Potentiodynamic Plots. Cyclic Polarization . . . they are all very similar.

In an embodiment corrosion resistance is measured by means of the oxide formation when immersing the steel in deionized water for 48 h at room temperature (25° C.). The oxide formation is compared with the oxide formation of H13 steel in the same conditions to determine if the steel is a high corrosion resistance steel.

In an embodiment a high corrosion resistance steel is referred to a steel having less than a half oxide formation when immersed in deionized water for 48 h compared with a H13 steel at room temperature (25° C.). In another embodiment the oxide formation is 10 times or less, in another embodiment is 100 times or less.

Given that there may be a few variability in the execution of a test of this type, t can be estimated the variability taking place in less than 60%, whereby for comparison purposes, when determining if there is corrosion effect the most adverse value obtained will be used.

A few variability in the composition of H13 steel is also possible, in this case also it can be estimated the variability occurring in less than 60%, and the most adverse value obtained will be used for comparison purposes.

In an embodiment the invention refers to a tool, die, piece or mould comprising a steel having a high stress corrosion cracking resistance. In an embodiment the invention refers to a tool, die, piece or mould which, in use, is able to transfer heat out, in and/or through it, comprising a steel having a high stress corrosion cracking resistance.

In an embodiment the invention refers to the use of a steel having a high stress corrosion cracking resistance for manufacturing a tool, die, piece or mould. In an embodiment the invention refers to the use of a steel having a high stress corrosion cracking resistance for manufacturing a tool, die, piece or mould, which, in use, is able to transfer heat out, in and/or through it.

In another embodiment the tool, die, piece or mould, further comprises an internal fluid circuit to refrigerate at least part of the tool, die, piece or mould. In another embodiment the tool, die, piece or mould, which, in use, is able to transfer heat out, in and/or through it, further comprises an internal fluid circuit to refrigerate at least part of the tool, die, piece or mould.

In an embodiment the fluid chosen for the internal cooling system is water; in another embodiment of the invention the fluid chosen for the internal cooling system is an aqueous solution, in another embodiment of the invention the fluid chosen for the internal cooling system is oi, including but not limited to mineral oil, animal oil and/or vegetal of: in another embodiment the fluid chosen for the internal cooling system are melted salts and even in another embodiment the fluid chosen for the internal cooling system are liquid metals.

Stress corrosion cracking has a nucleation phase, a propagation phase and a catastrophic failure phase. The inventor has seen that the nucleation phase can be neglected in terms of gaining resistance against this failure mechanism, because often enough the components will unavoidably have defects in the cooling circuits that will act as stress concentrators. Thus a material with high fracture toughness should be chosen if corrosion resistance cannot be provided in another way, and even when corrosion resistance is provided, high fracture toughness is very desirable for several applications as will be seen.

Stress corrosion cracking is cracking due to a process involving conjoint corrosion and straining of a metal due to residual or applied stresses. The occurrence of SCC depends on the simultaneous achievement of three requirements:

Susceptible material,
Environment that causes stress corrosion cracking for that material,
Sufficient tensile stress to induce stress corrosion cracking.

Stress corrosion cracking (Kiscc) can be evaluated by means of the threshold stress intensity for stress corrosion cracking according to ISO 7539-6 standard. The test involves subjecting a specimen, in which a crack has been developed from a machined notch by fatigue, to an increasing load or displacement during exposure to a chemically aggressive environment. The objective is to quantify the conditions under which environmentally-assisted crack extension can occur in terms of the threshold stress intensity for stress corrosion cracking, Kiscc, and the kinetics of crack propagation. Kiscc is a function of the environment, which should simulate that in service, and of the conditions of loading. In an embodiment stress corrosion cracking (Kiscc) is measured at room temperature (25° C.).

In an embodiment, in the context of the present application the value of Kiscc can be determined in a 3.5% NaCl solution at pH 6, and room temperature (25° C.). In another embodiment the value of Kiscc can be determined in a 3.5% NaCl solution using a reference electrode of Ag/AgCl and a scanning rate of 0.16 mV/s at room temperature (25° C.).

One embodiment refers to the use of steel having a high stress corrosion cracking resistance to manufacture a tool, die, piece or mould. In other embodiment refers to a tool, die, piece or mould comprising a steel having a high stress corrosion cracking resistance. In an embodiment the tool, die, piece or mould is a tool, die, piece or mould which, in use, is able to transfer heat out in and/or through it. In an embodiment a steel having a high stress corrosion cracking resistance is a steel wherein the Kiscc value measured according to ISO 7539-6 standard at room temperature (25° C.) is 35 MPa*m1/2 or more, in another embodiment 42 MPa*m1/2 or more, in another embodiment 46 MPa/m1/2 or more, in another embodiment 58 MPa/m1/2 or more.

One embodiment refers to the use of steel having a high stress corrosion cracking resistance to manufacture a tool, die, piece or mould. In other embodiment refers to a tool, die, piece or mould comprising a steel having a high stress corrosion cracking resistance. In an embodiment the tool, die, piece or mould is a tool, die, piece or mould which, in use, is able to transfer heat out in and/or through it, In an embodiment a steel having a high stress corrosion cracking resistance is a steel wherein the Kiscc value measured according to ISO 7539-6 standard at room temperature (25° C.) in a 3.5% NaCl solution at 25 pH 6, is 35 MPa*m1/2 or more, in another embodiment 42 MPa*m1/2 or more, in another embodiment 46 MPa*m1/2 or more, in another embodiment 58 MPa*m1/2 or more.

Any of the above-described embodiments can be combined with any other embodiment herein described in any combination, to the extent that the respective features are not incompatible.

When trying to gain effectiveness in the thermal management, the inventor has seen that two main factors can be exploited, using a material with high thermal conductivity for the tool and/or using an aggressive cooling strategy, making the cooling fluid flow dose to the surfaces where heat has to be extracted. Since the cooling fluid needs a void space to circulate, and a void space win act as a stress concentrator, and the surfaces to be cooled often coincide with surfaces with high mechanical loading, again in order to be able to apply such a strategy a material with high fracture toughness is required.

An embodiment refers to a tool, die, piece or mould, which, in use, is able to transfer heat out, in and/or through it, comprising a steel having a high fracture toughness. Another embodiment refers to a tool, die, piece or mould, comprising a steel having high environmental resistance and a high fracture toughness. Another embodiment refers to a tool, die, piece or mould comprising a steel wherein the steel further has a high wear resistance. Another embodiment refers to a tool, die, piece or mould comprising a steel having high fracture toughness and high wear resistance. Another embodiment refers to a tool, die, piece or mould, wherein the tool, die, piece or mould further incorporates an internal fluid circuit for refrigerate at least part of the tool, die, piece or mould.

An embodiment refers to the use of a steel having a high fracture toughness to manufacture a tool, die, piece or mould, which, in use, is able to transfer heat out, in and/or through it. Another embodiment refers to the use of a steel having high environmental resistance and a high fracture toughness to manufacture a tool, die, piece or mould, which, in use, is able to transfer heat out, in and/or through it. Another embodiment refers to the use of a steel further having a high wear resistance. Another embodiment refers to the use of a steel having high fracture toughness and high wear resistance to manufacture a tool, die, piece or mould which, in use, is able to transfer heat out, in and/or through it Another embodiment the tool, die, piece or mould further incorporates an internal fluid circuit for refrigerate at least part of the tool, die, piece or mould.

Any of the above-described embodiments can be combined with any other embodiment herein described in any combination, to the extent that the respective features are not incompatible.

When it comes to the tribological solicitations, to provide good wear resistance, it can be done with the embedding of high wear resistance ceramic particles in the tool material, either self-generated or added to the base material in the solicited zones.

In the case of heated dis, the inventor has realized that when tool steels are employed the problem of high temperature decarburization is surprisingly much more relevant than one could expect. In fact there are no references to this problem in the literature and the tool materials often chosen for such applications concentrate on the high temperature wear resistance of the materials employed but not on its decarburization propensity. To his own surprise the inventor has seen that this mechanism causes the real properties in the surface of the tool to be much lower than the nominal ones driving to an accelerated deterioration of the tool.

When referring to high temperature decarburization in some embodiments high temperature refers to a temperature above 200° C. in other embodiments above 210° C., in other embodiments above 355° C., in other embodiments above 410° C., in other embodiments above 510° C., in other embodiments above 620° C., in other embodiments above 655° C. and even in some embodiments above 710′C.

Decarburization is the carbon concentration reduction due to the exposure to high temperatures. Decarburization occurs when carbon atoms at the surface interact with the atmosphere and are removed from the material as a gaseous phase. Carbon from the interior diffuses towards the surface, moving from high to low concentration and continues until the maximum depth of decarburization is established or until the exposure is finished. Light microscopy polishes and etched cross-section and hardness measurement are used to determine the maximum affected depth according to ASTM E1077 standard.

In some embodiments decarburization is measured on the surface. In other embodiments decarburization is measured at 500 micrometers from the surface.

In an embodiment the steel selected to build the tool, die, piece or mould further has high resistance to decarburization at high temperature: in an embodiment the steel to manufacture the tool, die, piece or mould losses less than 15% of the total carbon content when used at high temperature; in an embodiment 45 the steel to manufacture the tool, die, piece or mould losses less than 20% of the total carbon content when used at high temperature; in an embodiment the steel to manufacture the tool, die, piece or mould losses less than 25% of the total carbon content when used at high temperature; in an embodiment the steel to manufacture the tool, die, piece or mould losses less than 30% of the total carbon content when used at high temperature: in an embodiment the steel to manufacture the tool, die, piece or mould losses less than 35% of the total carbon content when used at high temperature. In some embodiments the atmosphere of use is air with the theorical concentration of oxygen in the air.

In some embodiments the temperature of use is the theorical temperature of an air atmosphere with the theorical concentration of oxygen in the air.

When referring to the use at high temperature refers to the use at a temperature above 200° C., in other embodiments above 210° C., in other embodiments above 355° C., in other embodiments above 410° C., in other embodiments above 510° C., in other embodiments above 620° C., in other embodiments above 655° C. and even in some embodiments above 710° C.

In an embodiment the invention refers to a tool, die, piece or mould comprising a steel having high resistance to decarburization at high temperature: In an embodiment the invention refers to the use of a steel having high resistance to decarburization at high temperature to manufacture a tool, die, piece or mould. In an embodiment the tool, die, piece or mould is a tool, die, piece or mould which, in use, is able to transfer heat out, in and/or through it, in an embodiment refers to a tool, die, piece or mould comprising a steel wherein the steel losses less than 15% of the total carbon content when used at high temperature; in an embodiment refers to a tool, die, piece or mould comprising a steel wherein the steel losses less than 20% of the total carbon content when used at high temperature; in an embodiment refers to a tool, die, piece or mould comprising a steel wherein the steel losses less than 25% of the total carbon content when used high temperature; in an embodiment refers to a toot, die, piece or mould comprising a steel wherein the steel losses less than 30% of the total carbon content when used at high temperature; in an embodiment refers to a tool, die, piece or mould comprising a steel wherein the steel losses less than 35% of the total carbon content when used at high temperature. In some embodiments the carbon losses are measured after 2 h, in other embodiments after 3 h, in other embodiments after 4 h, in other embodiments after 8 h, In other embodiments after 12 h, and even in other embodiment after 24 h at the selected temperature.

In an embodiment the invention refers to a tool, die, piece or mould, which, in use, is able to transfer heat out, in and/or through it, comprising a steel having high fracture toughness and/or high resistance to decarburization. In an embodiment the steel further has high wear resistance.

In an embodiment, the invention is related to a tool, die, piece or mould for hot stamping, wherein the steel used to manufacture the tool, die, piece or mould, has a high environmental resistance and a high fracture 40 toughness: The too, die, piece or mould further can incorporate an internal fluid circuit comprising at least one cooling channel.

In an embodiment, the invention is related to the use of a the steel having a high environmental resistance and a high fracture toughness and high resistance to decarburization: to manufacture a tool, die, piece or mould, which, in use, is able to transfer heat out in and/or through it The tool, die, piece or mould further can incorporate an internal fluid circuit comprising at least one cooling channel.

In an embodiment, the invention is related to a tool, die, piece or mould for hot stamping, wherein the steel used to manufacture the tool, die, piece or mould, has a high corrosion resistance and a high fracture toughness: The tool, die, piece or mould further can incorporate an internal fluid circuit comprising at least one cooling channel.

In an embodiment, the invention is related to the use of a the steel having high corrosion resistance and a high fracture toughness and high resistance to decarburization; to manufacture a tool, die, piece or mould, which, in use, is able to transfer heat out, in and/or through it. The tool, die, piece or mould further can incorporate an internal fluid circuit comprising at least one cooling channel.

In an embodiment the invention is related to a tool, die, piece or mould for hot stamping, wherein the steel used to manufacture the tool, die, piece or mould, has a high resistance to stress corrosion cracking and a high fracture toughness: The tool, die, piece or mould further can incorporate an internal fluid circuit comprising at least one cooling channel.

In an embodiment, the invention is related to the use of a the steel having high resistance to stress corrosion cracking and a high fracture toughness and high resistance to decarburization; to manufacture a tool, die, piece or mould, which, in use, is able to transfer heat out, in and/or through it. The tool, die, piece or mould further can incorporate an internal fluid circuit comprising at least one cooling channel.

In an embodiment, the invention refers to a tool, die, piece or mould for hot stamping, comprising a steel having a high environmental resistance and a high fracture toughness. The tool, die, piece or mould further can incorporate an internal fluid circuit comprising at least one cooling channel.

In an embodiment, the invention is related to the use of a the steel having high environmental resistance and a high fracture toughness and high resistance to decarburization; to manufacture a tool, die, piece or mould, which, in use, is able to transfer heat out, in and/or through it. The tool, die, piece or mould further can incorporate an internal fluid circuit comprising at least one cooling channel.

In an embodiment, the invention refers to a tool, die, piece or mould for hot stamping, comprising a steel having a high corrosion resistance and a high fracture toughness. The tool, die, piece or mould further can incorporate an internal fluid circuit comprising at least one cooling channel.

In an embodiment, the invention is related to the use of a the steel having high corrosion resistance and a high fracture toughness and high resistance to decarburization to manufacture a tool, die, piece or mould, which, in use, is able to transfer heat out, in and/or through it. The tool, die, piece or mould further can incorporate an internal fluid circuit comprising at least one cooling channel.

In an embodiment, the invention refers to a tool, die, piece or mould for hot stamping, comprising steel having a high resistance to stress corrosion cracking and a high fracture toughness. The tool, die, piece or mould further can incorporate an internal fluid circuit comprising at least one cooling channel.

In an embodiment, the invention is related to the use of a the steel having high resistance to stress corrosion cracking and a high fracture toughness: to manufacture a tool, die, piece or mould, which, in use, is able to transfer heat out, in and/or through it. The tool, die, piece or mould further can incorporate an internal fluid circuit comprising at least one cooling channel.

In an embodiment, the invention refers to the use of a steel having a high environmental resistance and a high fracture toughness to manufacture a tool, die, piece or mould for hot stamping, comprising. The tool, die, piece or mould further can incorporate an internal fluid circuit comprising at least one cooling channel.

In an embodiment, the invention refers to the use of a steel having a high corrosion resistance and a high fracture toughness to manufacture a tool, die, piece or mould for hot stamping. The tool, die, piece or mould further can incorporate an internal fluid circuit comprising at least one cooling channel.

In an embodiment, the invention refers to the use of a steel having a high fracture toughness and high resistance to decarburization to manufacture a tool, die, piece or mould for hot stamping, comprising; The tool, die, piece or mould further can incorporate an internal fluid circuit comprising at least one cooling channel.

In an embodiment, the invention refers to the use of a steel having a high environmental resistance and high resistance to decarburization to manufacture a tool, die, piece or mould for hot stamping, comprising; The tool, die, piece or mould further can incorporate an internal fluid circuit comprising at least one cooling channel.

In an embodiment, the invention refers to the use of a steel having a high corrosion resistance and high resistance to decarburization to manufacture a tool, die, piece or mould for hot stamping, comprising; The tool, die, piece or mould further can incorporate an internal fluid circuit comprising at least one coding channel.

In an embodiment, the invention refers to the use of a steel having a high wear resistance and high resistance to decarburization to manufacture a tool, die, piece or mould for hot stamping, comprising; The tool, die, piece or mould further can incorporate an internal fluid circuit comprising at least one cooling channel.

In an embodiment, the invention refers to the use of a steel having a high resistance to stress corrosion cracking and high resistance to decarburization to manufacture a tool, die, piece or mould for hot stamping, comprising: The tool, die, piece or mould further can incorporate an internal fluid circuit comprising at least one cooling channel.

In an embodiment, the invention refers to the use of a steel having a high resistance to stress corrosion cracking and a high fracture toughness to manufacture a tool, die, piece or mould for hot stamping, comprising; The tool, die, piece or mould further can incorporate an internal fluid circuit comprising at least one cooling channel.

Another embodiment refers to the use of the tool, die, piece or mould for hot stamping, being useful to drive heat out and/or into desired parts of the die to create soft zones in the stamped component.

Any of the above-described embodiments can be combined with any other embodiment herein described in any combination, to the extent that the respective features are not incompatible.

One of the main difficulties in resolving the present problem is that besides the difficulty or realising which properties are wished in which areas of the tool, it is equally as difficult then attain a material with high wear resistance, high corrosion resistance, high fracture toughness and high mechanical strength simultaneously at the working temperature and conditions of the particular application. In addition a determined thermal conductivity will also be desirable also. The inventor has seen that when such a material is invented, it is the one that would be used in the present application, together with the other aspects of the present invention. In the absence of a material with such combination of properties, the inventor has seen ways to overcome at least one of the short-comings.

The tool materials used for such applications are:
Hot work tool steels: They have sufficient mechanical strength and considerable fracture toughness, but they lack corrosion resistance, and they have moderate thermal conductivity and wear resistance, especially at high working temperatures.
Copper base alloys: Very good thermal conductivity and sufficient corrosion resistance, but low mechanical resistance and very low wear resistance.
Martensitic Stainless steels: Good corrosion resistance, mechanical strength and wear resistance but very poor thermal conductivity and fracture toughness.
Precipitation hardening stainless steels: Very good resistance to stress corrosion cracking and fracture toughness, but rather too low mechanical strength and very low wear resistance and thermal conductivity.
High thermal conductivity tool steels: Very good thermal conductivity, mechanical strength, wear resistance and even fracture toughness if special heat treatment can be applied. Resistance to stress corrosion cracking is limited.

One important observation of the inventor has been that the material does not need to be stainless to present a sufficient resistance to stress corrosion cracking for most applications of the pieces and tools objective in the present invention, particularly if some additional measures are taken. In some cases the manufacturing route can help overcome the limitations trough proper material combinations and design.

As examples, thin films (sputtering, thermal spraying, cold spraying, galvanic, sol-gel or other wet chemistry, PVD, CVD, or any other functional thin film) can be used to provide some localized protection against wear, adhesion and even corrosion also additive manufacturing allows to use advanced designs and often even multi-materials.

In the case of heated dies for “soft”-zones, and similar applications, the typical tool materials used are:
Hot work tool steels: They lack wear resistance at high temperature thus leading to high wear. They also have very limited environment resistance.
High Speed Steels: Good theoretical mechanical and tribological resistance at working temperature, but sensitive to decarburization due to the high temperatures, non-protected environments and long exposure times.
High mechanical strength at high temperature alloys (normally with high % Ni, % Cr and/or % Co): Good oxidation resistance and even sufficient mechanical strength at high temperatures but poor wear resistance. They tend to have very high manufacturing costs due to alloying and machining difficulties.

A good solution for such problem would be easier if one could count on a material for the building of the components with simultaneously environmental resistance, mechanical strength, wear resistance and fracture toughness. Being the combination of environmental resistance and fracture toughness the one that allows to compensate for the lack of thermal conductivity by allowing to bring the cooling channels close to the working surface. In some embodiments lack of internal conductivity refers to a steel having low thermal conductivity, with the valued disclosed in this document.

In an embodiment environmental resistance is referred to the resistance to a determinate type environment, which may be oxidative, reductive or corrosive.

In another embodiment in an oxidative environment, a high environmental resistance steel is referred to a steel resistant to oxidation at 500° C. for 2 h, in another embodiment for 24 h, In another embodiment for 100 h and even in another embodiment for 1000 h. After this period of time the weight loss is determined for a component with defined dimensions, always the same, and compared with H13 steel, of the same defined dimensions, after submit the materials to a shot-peening treatment to eliminate the oxide. In an embodiment a high environmental resistance steel is a steel having 1/1.5 times or less weight loss than H13 steel, in another embodiment a high environmental resistance steel is a steel having 1/2 times or less weight loss than material H13 steel, in another an embodiment a high environmental resistance steel is a steel having 113 times or less weight loss than H13 steel, in another embodiment a high environmental resistance steel is a steel having 1110 times or less weight loss than H13 steel. In some embodiments weight loss is measured at room temperature (25° C.). In some embodiments the H13 steel used is H13 steel heat treated according to NADCA #229-2016 to a hardness of 42-46 Hrc. In some other embodiments the H13 steel used is H13 steel hardened to 50 HRc with a secondary hardness temper.

In another embodiment in a corrosive environment, high environmental resistance steel is referred to a steel resistant to corrosion when the ion used is chlorine, in another embodiment the ion used may be selected from fluorine or bromine among others. In another embodiment in a corrosion environment, high environmental resistance steel is referred to a steel resistant to corrosion when the ion used is chlorine for 302 h. in another embodiment for 24 h, in another embodiment for 100 h and even in another embodiment for 1000 h. After this period of time the weight loss is determined for a component with a defined dimensions, always the same, and compared with material H13, of the same defined dimensions, after submit the materials to a shot-peening treatment to eliminate the corrosion. In an embodiment high environmental resistance steel is a steel having 1/1.5 times or less weight loss than material H13, in another embodiment high environmental resistance steel is a steel having 1/2 times or less weight loss than H13 steel, in another an embodiment high environmental resistance steel is a steel having 1/3 times or less weight loss H13 steel, in another embodiment high environmental resistance steel is a steel having 1/10 times or less weight loss than H13 steel. In some embodiments weight loss is measured at room temperature (25° C.). In some embodiments the H13 steel used is H13 steel heat treated according to NADCA #229-2016 to a hardness of 42-46 HRc. In some other embodiments the H13 steel used is H13 steel hardened to 50 HRc with a secondary hardness temper.

In another embodiment in a reductive environment, high environmental resistance steel is referred to a steel with a 28% more resistance than H13 steel measured in a standard test using a reductive medium such as hydrogen or caustic soda among others. In another embodiment the steel has 56% more resistance than H13 steel, in another embodiment the steel has 120% more resistance than H13 steel; in another embodiment the steel has 430% more resistance than H13 steel in some embodiments weight loss is measured at room temperature (25° C.). In some embodiments the H13 steel used is H13 steel heat treated according to NADCA #229-2016 to a hardness of 42-46 HRc. In some other embodiments the H13 steel used is H13 steel hardened to 50 HRc with a secondary hardness temper.

Given that there may be a few variability in the execution of a test of this type, it can be estimated the variability taking place in less than 60%, whereby for comparison purposes, when determining if there is environmental resistance the most adverse value obtained will be used.

A few variability in the composition of H13 steel is also possible, in this case also it can be estimated the variability occurring in less than 60%, and the most adverse value obtained will be used for comparison purposes

In an embodiment, in at least part of the surface of the tool, die, piece or mould is further deposited a thin film: in another embodiment the thin film is deposited using sputtering, thermal spraying, galvanic, cold spraying, sot gel, wet chemistry, physical vapour deposition (PVD), chemical vapour deposition (CVD), additive manufacturing, direct energy deposition, LENS cladding among others and/or any combination of them.

In another embodiment specific parts of the tool, die, piece or mould which, in use, is able to transfer heat out, in and/or through it can be reinforced in of the surface using deposition laser, and projection of hard particles such as carbides, nitrides, oxides and borides among others and/or any combination of them.

This local reinforcement could be interesting to provide resistance against corrosion, wear and/or adhesion.

In another embodiment at least part of the tool, die, piece or mould is protected using a thin film, deposited on the surface to provide resistance against corrosion, wear and/or adhesion.

Any of the above-described embodiments can be combined with any other embodiment herein described in any combination, other extent that the respective features are not incompatible.

Particularly interesting are the components manufactured with any AM technology or another manufacturing technology that allows to manufacture very complex geometries, since those are often requiring the extreme property combination described for the components of the present invention. One particular example will be provided with what will be called “sweating” die in the present application, whether it is with aleatory interlinked porosity or with regular or determined channels.

In an embodiment the tool, die, piece or mould, of the invention is obtained by additive manufacturing (AM).

In the case of “soft” zones the material should present high mechanical strength and high wear resistance at the working temperature but also resistance to decarburization or surface deterioration by the environment at the working temperature.

In an embodiment, the invention refers to a tool, die, piece or mould comprising a steel having high mechanical strength and/or high resistance to decarburization, in an embodiment, the invention refers to a tool, die, piece or mould comprising a steel having high mechanical strength and high wear resistance in an embodiment, the invention refers to a tool, die, piece or mould comprising a steel having high mechanical strength and/or high wear resistance and/or high resistance to decarburization. In an embodiment, the invention refers to a tool, die, piece or mould comprising a steel having high mechanical strength and high wear resistance and high resistance to decarburization. In another embodiment, the tool, die, piece or mould further comprises a internal fluid circuit. In some embodiments the tool, die, piece or mould refers to a tool, die, piece or mould which, in use, is able to transfer heat out, in and/or through it.

In an embodiment, the invention refers to refers to the use of a steel having high mechanical strength and/or high resistance to decarburization to manufacture a tool, die, piece or mould. In an embodiment, the invention refers to a tool, die, piece or mould comprising a steel having high mechanical strength and high wear resistance in an embodiment, the invention refers to a tool, die, piece or mould comprising a steel having high mechanical strength and/or high wear resistance and/or high resistance to decarburization. In an embodiment, the invention refers to a tool, die, piece or mould comprising a steel having high mechanical strength and high wear resistance and high resistance to decarburization. In another embodiment, the tool, die, piece or mould further comprises a internal fluid circuit. In some embodiments the tool, die, piece or mould refers to a tool, die, piece or mould which, In use, is able to transfer heat out, in and/or through it.

In an embodiment, the invention refers to the use of a steel having high mechanical strength, high wear resistance and high resistance to decarburization to manufacture a tool, die, piece or mould which, in use, is able to transfer heat out, in and/or through it. In another embodiment, the tool, die, piece or mould further comprises an internal fluid circuit.

The mechanical strength of a material is its ability to withstand an applied load without failure or plastic deformation. It can be measured by mean of tensile test according to ISO 6892 or ASTM E8. Material strength testing, using the tensile test or tension test, Involves applying an ever-increasing load to a test sample up to the point of failure. The process creates a stress/strain curve showing how the material reacts throughout the tensile test. The data generated during tensile testing are used to determine mechanical properties of materials such as yield strength (R0,2), tensile strength, elongation, area reduction, etc. In an embodiment in case of tensile test, tensile strength is taken as equivalent to mechanical strength.

In some embodiment, a steel having a tensile strength of 1260 MPa or more at room temperature (25° C.) is considered a steel having high mechanical strength. In an embodiment mechanical strength is tensile strength.

One embodiment refers to the use of steel having a high mechanical strength to manufacture a tool, die, piece or mould. In other embodiment refers to a tool, die, piece or mould comprising a steel having a high mechanical strength. In an embodiment the tool, die, piece or mould is a tool, die, piece or mould which, in use, is able to transfer heat out, in and/or through it. In an embodiment a steel having a high mechanical strength is a steel having a tensile strength at room temperature (25° C.) of 1260 MPa or more: in another embodiment 1420 MPa or more: in another embodiment 1660 MPa or more: in another embodiment 1740 MPa or more; in another embodiment 1860 MPa or more in another embodiment 1930 MPa or more. In some embodiments the above disclosed values for mechanical strength are the values obtained at 200° C., in other embodiment at 250° C., in other embodiment at 300° C., in other embodiment at 350° C., in other embodiment at 400° C. in other embodiment at 450° C. in other embodiment at 50oC, in other embodiment at 550° C., in other embodiment at 600° C., in other embodiment at 700° C. and even in other embodiments at 750° C.

Any of the above-described embodiments can be combined with any other embodiment herein described in any combination, to the extent that the respective features are not incompatible.

As an explanatory example, a material with resistance to stress corrosion cracking and high fracture toughness but lacking thermal conductivity, can be employed by using an aggressive cooling strategy to overcome or minimize the effect of the limited thermal conductivity. This can be achieved through additive manufacturing, layered manufacturing, and for some geometries even with conventional manufacturing routes. The problem is the propensity of such a solution to fail due to cracking from the cooling channels, which the inventor has seen can be minimized when the material has some improved resistance to stress corrosion cracking and a high fracture toughness for the stress level employed.

Fracture toughness is an indication of the amount of stress required to propagate a preexisting flaw that can appear as cracks, voids, metallurgical inclusions, weld defects, design discontinuities, or some combination thereof. A parameter called the stress-intensity factor. K is used to determine the fracture toughness. The fracture toughness Kic is the critical value of the stress intensity factor at a crack tip needed to produce catastrophic failure under simple uniaxial loading and can measured according to ASTM E399 standard. This test method involves testing of notched specimens that have been precracked in fatigue by loading either in tension or three-point bending.

For some applications as has been described, the inventor has seen that the relevant parameter to take into account is not the absolute value of fracture toughness, but its relation to the yield strength of the material. In such cases the inventor has seen that to evaluate the appropriateness of a given material for the application is through the following parameter (Y), which has units of fracture toughness, then the actual fracture toughness of the material has to be compared to Y, and when its value is greater or equal to Y the material is appropriate for such applications. In the calculation of Y the yield strength has to be provided in megapascals (MPa), and the value of the fracture toughness to compare to Y has to be provided in megapascals per square root of meter (MPa*m^{1/2}). To obtain the parameter Y, one has to know the yield strength of the material in the conditions of usage which are also the conditions at which the comparative fracture toughness should be measured. In the equation X usually refers to the yield strength in tension which is measured in megapescals. The appropriate values for A and B will be commented shortly.

Y=A−B*X

The inventor has seen that for some applications when evaluating the parameter Y one should use the mechanical strength in the universal tension test as X. For some other applications one should use the yield strength in compression for X.

Depending on the application different values for A and B should be chosen. Often it is desirable to have A=96 and 8=0.0349, preferably A= and 8=, more preferably A= and B= and even A=210 and B=0.075.

In an embodiment Kic is measured according to ASTM E399 standard at room temperature (25° C.), in other embodiment at 200° C., in other embodiment at 250° C., in other embodiment at 300° C., in other embodiment at 350° C., in other embodiment at 400° C. in other embodiment at 450° C., in other embodiment at 500° C., in other embodiment at 550° C., in other embodiment at 600° C., in other embodiment at 700° C. and even in other embodiments at 750° C.

In an embodiment yield strength (R0,2) is measured according to ISO 8892 or ASTM E8 at room temperature (25° C.). In other embodiment at 200° C., in other embodiment at 250° C., in other embodiment at 300° C., in other embodiment at 350° C., in other embodiment at 400° C., in other embodiment at 450° C., in other embodiment at 500° C., in other embodiment at 550° C., in other embodiment at 600° C., in other embodiment at 700° C. and even in other embodiments at 750° C.

In an embodiment, a steel having a fracture toughness (Kic) value of 55 MPa*m^{1/2} or more for a yield strength (R0,2) value of less than 1200 MPa or a fracture toughness value Kic≥65−0.092(R0,2-1200); for a yield strength (R0,2) values higher than 1200 MPa is considered a steel having a high fracture toughness.

One embodiment refers to the use of steel having a high fracture toughness, to manufacture a tool, die, piece or mould. In other embodiment refers to a tool, die, piece or mould comprising a steel having a high fracture toughness. In an embodiment the tool, die, piece or mould is a tool, die, piece or mould which, in use, is able to transfer heat out, in and/or through it. In an embodiment a steel having a high fracture toughness is a steel wherein the (Kic) value is 55 MPa*m^{1/2} or more for a yield strength (R_{0,2}) value of less than 1200 MPa: in another embodiment the (Kic) value is 66 MPa*m^{1/2} or more for a yield strength (Ru) value of less than 1200 MPa; in another embodiment the (Kic) value is 76 MPa^{1/2} or more for a yield strength (R_{0,2}) value of less than 1200 MPa; in another embodiment the (Kic) value is 81 MPa*m^{1/2} or more for a yield strength (R_{0,2}) value of less than 1200 MPa; in another embodiment the (Kic) value is 87 MPa*m^{1/2} or more for a yield strength (R_{0,2}) value of less than 1200 MPa; in another embodiment the (Kic) value is 92 MPa*m^{1/2} or more for a yield strength (R_{0,2}) value of less than 1200 MPa: in another embodiment the (Kic) value is 101 MPa*m^{1/2} or more for a yield strength (R_{2,2}) value of less than 1200 MPa; in another the (Kic) value is 109 MPa*m^{1/2} or more for a yield strength (R_{2,2}) value of less than 1200 MPa; in another embodiment the (Kic) value is 116 MPa*m^{1/2} or more for a yield strength (R_{0,2}) value of less than 1200 MPa: in another embodiment the Kic≥65-0.092(R_{0,2}1200) for a yield strength (R_{2,2}) values higher than 1200 MPa, in another embodiment, the Kic≥72-0.092*(R_{0,2*}1200) or a yield strength (R_{0,2}) values higher than 1200 MPa, in another embodiment the Kic≥81-0.092*(R_{0,2*}1200) for a yield strength (R₂) values higher than 1200 MPa; in another embodiment the Kic≥293-0.092*(R_{0,2*}1200) for a yield strength (R_{0,2}) values higher than 1200 MPa; in another embodiment the Kic≥104-0.092-(R_{0,2*}200) for a yield strength (R_{0,2}) values higher than 1200 MPa: in another embodiment the Kic≥115-0.113*(R_{0,2*}1200) for a yield strength (R_{0,2}) values higher than 1200 MPa.

Any of the above-described embodiments can be combined with any other embodiment herein described in any combination, to the extent that the respective features are not incompatible

In an embodiment the tool, die, piece or mould is obtained by additive manufacturing.

In another embodiment the tool, die, piece or mould, which, in use, is able to transfer heat out, in and/or through it comprises a steel having high corrosion resistance, a high fracture toughness, incorporates an internal fluid circuit and is obtained by additive manufacturing.

In another embodiment the invention refers to the use of a steel having high corrosion resistance, high fracture toughness to manufacture a tool, die, piece or mould, which, in use, is able to transfer heat out, in and/or through it wherein the tool die, piece or mould further, incorporates an internal fluid circuit and is obtained by additive manufacturing.

In another embodiment the tool, die, piece or mould, which, in use, is able to transfer heat out, in and/or through it comprises a steel having high stress corrosion cracking resistance, a high fracture toughness, incorporates an internal fluid circuit and is obtained by additive manufacturing.

In another embodiment the invention refers to the use of a steel having a steel having high stress corrosion cracking resistance, high fracture toughness to manufacture a tool, die, piece or mould, which, in use, is able to transfer heat out, in and/or through it wherein the tool, die, piece or mould further, incorporates an internal fluid circuit and is obtained by additive manufacturing.

In another embodiment the tool, die, piece or mould, which, in use, is able to transfer heat out, in and/or through it, comprises a steel further having a high wear resistance and/or high mechanical strength.

Any of the above-described embodiments can be combined with any other embodiment herein described in any combination, to the extent that the respective features are not incompatible.

Another embodiment of the invention is referred to a tool, die, piece or mould, which, in use, is able to transfer heat out, in and/or through it comprising a steel having a high stress corrosion cracking resistance, a high fracture toughness and a local wear reinforcement, in another embodiment the tool die, piece or mould, which, in use, is able to transfer heat out, in and/or through it, comprises a steel having a high stress corrosion cracking resistance, a high fracture toughness and a local wear reinforcement and further incorporates an internal fluid circuit for refrigerate at least part of the tool, die, piece or mould.

Another embodiment of the invention is referred to the use of a steel having high stress corrosion cracking resistance, a high fracture toughness and a local wear reinforcement to manufacture a tool, die, piece or mould, which, in use, is able to transfer heat out, In and/or through it, In another embodiment is referred to the use of high stress corrosion cracking resistance, a high fracture toughness and a local wear reinforcement and further incorporates an internal fluid circuit for refrigerate at least part of the tool, die, piece or mould a steel to manufacture a tool, die, piece or mould, which, in use, is able to transfer heat out, in and/or through it.

Another embodiment of the invention is referred to a tool, die, piece or mould, which, in use, is able to transfer heat out, in and/or through it comprising steel having high thermal conductivity, and a high wear resistance, incorporating a local corrosion protection.

Another embodiment of the invention is referred to the use of a steel having high thermal conductivity, and a high wear resistance, incorporating a local corrosion protection to manufacture a tool, die, piece or mould, which, in use, is able to transfer heat out, in and/or through it.

Any of the above-described embodiments can be combined with any other embodiment herein described in any combination, to the extent that the respective features are not incompatible.

Degradation and failure of structures, tools, die, moulds, pieces or machine part tools represent a huge cost. Material properties play a determinant role in durability of many components, such as tools, dies, moulds or pieces. In an embodiment the technical effects of the above disclosed embodiments include a reduction in cost and long durability of the components due to the properties of the steel used to manufacture the tool, die, piece or mould such as fracture toughness, environmental resistance, corrosion resistance, stress corrosion cracking resistance, mechanical strength, and/or wear resistance. In several embodiments, the invention also provides a reduction in the time spent on cooling which would drastically increase the production rate as well as reduce costs.

One embodiment is a tool, die, piece or mould, comprising a steel having a tensile strength above 1260 Mpa at 450° C. and/or high resistance to decarburization wherein the steel losses less than 20% of the total carbon contained at 500 micrometres from the surface after maintaining in air during 8 h at 500° C.

One embodiment is a tool, die, piece or mould, comprising a steel having a tensile strength above 1260 Mpa at 450° C. and/or high resistance to decarburization wherein the steel losses less than 20% of the total carbon the carbon losses measured on the surface after maintaining in air during 8 h at 500° C. One embodiment is a tool, die, piece or mould, comprising a steel having a tensile strength above 1260 Mpa at 450° C. and/or high resistance to decarburization wherein the steel losses less than 20% of the total carbon contained at 500 micrometers from the surface after maintaining in air during 8 h at 500° C., wherein the steel has a thermal conductivity below 24 W/mK.

One embodiment is a tool, die, piece or mould, comprising a steel having a tensile strength above 1260 MPa at 450° C. and/or high resistance to decarburization wherein the steel losses less than 20% of the total carbon contained at 500 micrometres from the surface after maintaining in air during 8 h at 500° C. wherein the steel has a 20% or more wear resistance than H13 steel heat treated according to NADCA #229-2016 to a hardness of 4246 HRc.

One embodiment is a tool, die, piece or mould, comprising a steel having a tensile strength above 1260 MPa at 450° C. and/or high resistance to decarburization wherein the steel losses less than 20% of the total carbon contained at 500 micrometres from the surface after maintaining in air during 8 h at 500° C., wherein the steel has a 20% or more wear resistance than H13 steel hardened to 50 HRc with a secondary 40 hardness temper.

Additive Manufacturing is a set of technologies that have broadly increased the accuracy with which many structures can be replicated. Solid freeform fabrication or rapid prototyping (RP) is the automatic construction of physical objects using additive manufacturing technology, which is colloquially referred to as “3D printing”. This technology builds up parts and components by adding materials one layer at a time based on a computerized 3D solid model. It is considered by many authors as “the third industrial revolution” as it allows design optimization and production of customized parts on-demand. Additive manufacturing technologies can be classified in several categories, as presented in the document F2792-12a by the ASTM International, where seven classifications are considered: i) binder jetting, ii) directed energy deposition, iii) material extrusion, iv) material jetting, v) powder bed fusion, vi) sheet lamination, and vii) vat photopolymerization. Each technology classification includes a set of different material classifications and discrete manufacturing technologies. Thus, additive manufacturing includes numerous technologies such as fused deposition modelling, selective laser sintering/melting, laser engineered net shaping, 3D printing, direct ink writing, laminated object manufacturing, digital light processing, and stereolithography among others. In some embodiments any additive manufacturing method may be used to manufacture the tool, die, piece or mould disclosed in this document and may be combined with any embodiment disclosed in this document provided they are not mutually excusive.

Any embodiment disclosed in this document can be combined with any other embodiment disclosed in this document in any combination, to the extent that the respective features are not incompatible.

### EXAMPLES

Several examples have been conducted. Examples are to be considered as an exemplification of the invention, and are not intended to limit the invention to the specific embodiments illustrated.

### Example 1

Several steels with high resistance to chloride stress corrosion cracking and high fracture toughness at different yield strength were manufactured. These steels are disclosed in examples 1A, 1B, 1C, 1D and 1E.

These steels are useful for a tool, die, piece and a mould which also further can include an internal fluid circuit with cooling channels distributed along the steel.

### Example 1 A

A steel for a tool die or piece having the following composition, all percentages being in weight percent

| | | |
|---|---|---|
| % C = 0.02 | % Cr = 11.5 | % Ni = 11.0 |
| % Si máx. 0.25 | % Mn máx. 0.25 | % Mo = 1.0 |
| % Ti = 1.65 | | |

The rest consisting on iron and trace elements,

Stress corrosion cracking (Kiscc) was determined in a solution at 3.5% NaCl, using a reference electrode of Ag/AgCl and a scanning rate of 0.16 mV/s pH 6 at 25° C., This steel has a Kiscc value of 58 MPa*m^{1/2}.

For this steel, different fracture toughness values (Kic) were determined at different yield strength (R0,2), as shown in Table 1.

TABLE 1
Fracture toughness at different yield strength

| Kic (MPa*m^{1/2}) | R_{0, 2} (MPa) |
|---|---|
| 110 | 1070 |
| 95 | 1234 |
| 78 | 1296 |
| 125 | 1413 |
| 77 | 1551 |
| 98 | 1648 |

### Example 1B

A steel for a tool die or piece having the following composition, all parentages being in weight percent:

| | | |
|---|---|---|
| % C = 0.001 | % Cu = 2.2 | % Cr = 11.5 |
| % Ni = 8.6 | % Ti = 1.3 | % Nb = 0.3 |

The rest consisting on iron and trace elements.

Stress corrosion cracking (Kiscc) was determined in a solution at 3.5% NaCl, using a reference electrode of Ag/AgCl and a scanning rate of 0.16 mV/s, pH 6 at 25° C. This steel has a Kiscc value of 46 MPa*m^{1/2}.

For this steel, different fracture toughness values (Kic) were determined at different yield strength (R₂), as shown in Table 2.

TABLE 2
Fracture toughness at different yield strength

| Kic (MPa*m^{1/2}) | R_{0, 2} (MPa) |
|---|---|
| 107 | 1380 |
| 79 | 1550 |
| 56 | 1680 |

### Example 1 C

A steel for tool die or piece having the following composition, A percentages being in weight percent

| | | |
|---|---|---|
| % C = 0.001 | % Cr = 12.7 | % Ni = 8 |
| % Mo = 2.3 | % Al = 1.2 | |

The rest consisting on iron and trace elements.

Stress corrosion cracking (Kiscc) was determined in a 3.5% NaCl solution, pH 6 at 25° C., This steel has a Kiscc value of 59 MPa*m^{1/2}.

For this steel, different fracture toughness values (K) were determined at different yield strength (R0,2), as shown in Table 3.

TABLE 3
Fracture toughness at different yield strength

| Kic (MPa*m^{1/2}) | R_{0, 2} (MPa) |
|---|---|
| 120 | 1410 |
| 97 | 1490 |

### Example 1 D

A steel for a tool die or piece having the following composition, all percentages being in weight percent

| | | |
|---|---|---|
| % C = 0.001 | % Cr = 15 | % Ni = 4 |
| % Nb = 0.3 | % Cu = 3.5 | |

The rest consisting on iron and trace elements.

Stress corrosion cracking (Kiscc) was determined in a solution at 3.5% NaCl, using a reference electrode of Ag/AgCl and a scanning rate of 0.16 mV/s, pH 6. Al 25° C. This steel has a Kiscc value of 68 MPa*m^{1/2}.

For this steel, different fracture toughness values (Kic) were determined at different yield strength (R_{0,2}), as shown in Table 4.

TABLE 4
Fracture toughness at different yield strength

| Kic (MPa*m^{1/2}) | R_{0, 2} (MPa) |
|---|---|
| 120 | 1030 |
| 98 | 1230 |

### Example 1 E

A steel for a tool die or piece having the following composition, all percentages being in weight percent

| | | |
|---|---|---|
| % C = 0.07 | % Cr = 16.6 | % Ni = 4.1 |
| % Mn = 1.0 | % Cu = 4.2 | % Nb = 0.31 |

The rest consisting on iron and trace elements.

Stress corrosion cracking (Kiscc) was determined in a solution at 3.5% NaCl, using a reference electrode of Ag/AgCl and a scanning rate of 0.16 mV/s, pH 6 at 25° C. This steel has a Kiscc value of 61 MPa*m^{1/2}.

For this steel, different fracture toughness values (Kic) were determined at different yield strength (R0,2), as shown in Table 4.

TABLE 4
Fracture toughness at different yield strength

| Kic (MPa*m^{1/2}) | R_{0, 2} (MPa) |
|---|---|
| 103 | 1070 |
| 60 | 1180 |

Several steels useful for a tool, die, piece and a mould were manufactured and disclosed in examples 3A, 3B, 3C, 3D, 3F, 3G, 3H, 3I, 3J.

Table 5 shows the composition in weigh percent of several elements of these steels, the rest consisting on iron and trace elements.

These steels further can include an internal fluid circuit with cooling channels distributed along the steel.

TABLE 5
Composition of several steels in weigth percent,
the rest consisting on iron and trace elements.

| | Compound | | | | | | | | |
|---|---|---|---|---|---|---|---|---|---|
| Example | C | Cr | Mn | Al | Ni | Si | Ti | V | Co |
| 3A | 1.4 | 8 | 16 | | 6 | | | 4 | 2 |
| 3B | 1.4 | 14 | 16 | 3 | 6 | 2 | 2 | | 2 |
| 3C | 1.4 | 8 | 16 | 8.5 | | | | | |
| 3D | 1.4 | 8 | 16 | 8.5 | 5 | 2 | 2 | 2.5 | 2 |
| 3E | 1.4 | 8 | 25 | 8.5 | | | | | |
| 3F | 1.4 | 18 | 25 | 8.5 | | | | | |
| 3G | 1.8 | 12 | 16 | 8.5 | 5 | 4 | 2 | 3 | 2 |
| 3H | 1.8 | 8 | 25 | 8.5 | 5 | 2 | 2 | 2.5 | 2 |
| 3I | 1.4 | 18 | 16 | 8.5 | | | | | |

The rest consisting on iron and trace elements.

### Example 4

A die manufactured with a steel with a tensile strength above 1260 MPa measured at 450° C. according to ASTM E8 and a resistance to decarburization less than 20% by weight when maintained in air atmosphere for 8 h in air at 500° C. Measurements for carbon lost can be made on the surface on the steel and at 500 micrometers from the surface.

A die manufactured using a steel with a tensile strength above 1660 MPa measured at 300° C. according to ASTM E8 and a resistance to decarburization less than 35% by weight measured at 500 micrometers from the surface when maintained in air atmosphere for 8 h in air at 500° C.

A die manufactured using a steel with a tensile strength above 1420 MPa measured at room temperature (25° C.) according to ASTM E8 and a resistance to decarburization less than 20% by weight measured in the surface, when maintained in air atmosphere for 8 h in air at 500° C.

A die manufactured using a steel with a tensile strength above 1930 MPa measured at 400° C. According to ASTM E8 and a resistance to decarburization less than 20% by weight measured in the surface, when maintained in air atmosphere for 8 h in air at 500° C.

A die manufactured using a steel with a tensile strength above 1740 MPa measured at 200° C. according to ASTM E8 and a resistance to decarburization less than 35% by weight measured in the surface, when maintained in air atmosphere for 8 h in air at 500° C.

### Example 5

A steel having the following composition, wherein % are in weight percent, used to manufacture a mould:

| | | | |
|---|---|---|---|
| % Ceq = 0.36-2.8 | % C = 0.36-2.8 | % N = 0-2 | % B = 0-2 |
| % Cr = 8-22 | % Ni = 0-14 | % Si = 0-1.4 | % Mn = 0-6 |
| % Al = 0-3.8 | % Mo = 0-7 | % W = 0-7 | % Ti = 0-3.8 |
| % Ta = 0-7 | % Zr = 0-3 | % Hf = 0-3 | % V = 0-7 |
| % Nb = 0-3 | % Cu = 0-4.8 | % Co = 0-6 | |

The rest consisting on iron and trace elements.

wherein % Ceq=% C+0.86*% N+1.2*% B and wherein the thermal conductivity is below 24 W/mK.

### Example 6

A tool manufactured using a steel with a tensile strength above 1420 MPa measured at room temperature (25° C.) according to ASTM E8 and resistance to decarburization wherein carbon lost less than 35% by weight, for 8 h in air and then the % C lost is measured. Measurements can be made on the surface on the steel and at 500 micrometers from the surface, and having a 20% more wear resistance measured according to ASTM G99 standard than H13 steel heat treated according to NADCA #229-2016 to a hardness of 42-46 HRc.

### Example 7

Five dies manufactured with a steel having the tensile strength and decarburization resistance of the dies disclosed in example 4 and having a 20% more wear resistance measured according to ASTM G99 standard than H13 steel heat treated according to NADCA #229-2016 to a hardness of 42-46 HRc. Five dies manufactured with a steel having the tensile strength and decarburization resistance of the dies disclosed in example 4 and having a 20% more wear resistance measured according to ASTM G99 standard than H13 steel hardened to 50 HRc with a secondary hardness temper.

### Example 8

A mould with a thermal conductivity is below 24 W/mK manufactured with a resistance to decarburization less than 20% by weight measured on the surface when maintained in air atmosphere for 8 h in at 500° C.

A mould with a thermal conductivity is below 24 W/mK manufactured with a resistance to decarburization less than 35% by weight measured on the surface when maintained in air atmosphere for 8 h in at 500° C.

Measurements for carbon lost can be made on the surface on the steel and at 500 micrometers from the surface.

### Example 9

A die manufactured using a steel with a tensile strength above 1420 MPa measured at room temperature (25° C.) according to ASTM E8 and a resistance to decarburization less than 20% by weight measured in the surface, when maintained in air atmosphere for 8 h in air at 500° C. and an environmental resistance having 11.5 times or less weight loss than H13 steel heat treated according to NADCA #229-2016 to a hardness of 42-46 Hrc, in an oxidative environment at 500° C. for 2 h

A die manufactured using a steel with a tensile strength above 1930 MPa measured at 250° C. according to ASTM E8 and a resistance to decarburization less than 20% by weight measured in the surface, when maintained in air atmosphere for 8 h in air at 500° C. and an environmental resistance having 1/2 times or less weight loss than H13 steel hardened to 50 HRc with a secondary hardness temper in an oxidative environment at 5° C. for 2 h

A die manufactured using a steel with a tensile strength above 1740 MPa measured at 200° C. according to ASTM E8 and a resistance to decarburization less then 35% by weight measured in the surface, when maintained in air atmosphere for 8 h in air at 500° C. and an environmental resistance having 1/10 times or less weight loss than H13 steel hardened to 50 HRc with a secondary hardness temper in an oxidative environment at 500° C. for 2 h

A die manufactured with a steel with a tensile strength above 1260 MPa measured at 450° C. according to ASTM E8 and a resistance to decarburization less than 20% by eight measured on the surface when maintained in air atmosphere for 8 h in air at 500° C. and an environmental resistance having 1/10 times or less weight loss than H13 steel hardened to 50 HRc with a secondary hardness temper in an oxidative environment at 500° C. for 2 h.

A die manufactured using a steel with a tensile strength above 1660 MPa measured at 300° C. according to ASTM ES and a resistance to decarburization less than 35% by weight measured at 500 micrometers from the surface when maintained in air atmosphere for 8 h in air at 500° C. and an environmental resistance having 1/1.5 times or less weight loss than H13 steel heat treated according to NADCA #229-2016 to a hardness of 42-46 Hrc, in an oxidative environment at 500° C. for 2 h

### Example 10

A steel for manufacturing a tool die or piece having the following composition, all percentages being in weight percent

| | | | |
|---|---|---|---|
| % Ceq = 0.8-1.8 | % C = 0.8-1.8 | % N = 0-1.8 | % B = 0-1.8 |
| % Mn = 12-22 | % Cr = 5-13 | % Al = 4.5-12.5 | |

further comprising % Ni+% V+% Nb+% Sn+% Si+% Ti+% Co+% W+% Mo=0-9.8

The rest consisting on iron and trace elements.

The steel having for a yield strength (R02) values higher than 1200 MPa, the steel has a high fracture toughness wherein Kic≥65-0.092° (R0,2-1200).

### Example 11

A steel for manufacturing a tool die or piece having the following composition, all percentages being in weight percent

| | | | |
|---|---|---|---|
| % C_{eq} = | % C = | % N = 0-0.1 | % B = 0-0.1 |
| 0.0001-0.14 | 0.0001-0.14 | | |
| % Cr = 8-22 | % Ni = 3-14 | % Si = 0-0.89 | % Mn = 0-0.89 |
| % Al = 0-3.8 | % Mo = 0-7 | % W = 0-7 | % Ti = 0-3.8 |
| % Ta = 0-7 | % Zr = 0-7 | % Hf = 0-7 | % V = 0-7 |
| % Nb = 0-7 | % Cu = 0-4.8 | % Co = 0-6 | |

The rest consisting on iron and trace elements.

Further embodiments can be found in the claims.

1. A tool, die, piece or mould, comprising a steel having a tensile strength above 1260 MPa at 450° C. measured according to ASTM E8 and/or resistance to decarburization wherein the steel losses less than 20% of the total carbon contained at 500 micrometres from the surface after maintaining in air during 8 h at 500° C.

2. The tool, piece or mould according to claim 1, wherein the carbon losses are measured on the surface.

3. The tool, piece or mould according to claim 1, wherein the steel has a thermal conductivity below 24 W/mK.

4. The tool, piece or mould according to claim 1, wherein the steel has a 20% or more wear resistance than H13 steel heat treated according to NADCA #229-2016 to a hardness of 42-46 HRc.

5. The tool, piece or mould according to claim 1, wherein the steel has a 20% or more wear resistance than H13 steel hardened to 50 HRc with a secondary hardness temper, measured according to ASTM 099 standard.

6. The tool, piece or mould according to claim 1, wherein the steel has an environmental resistance having 1/1.5 times or less weight loss than H13 steel heat treated according to NADCA #229-2016 to a hardness of 42-46 HRc, in an oxidative environment at 500° C. for 2 h.

7. The tool, piece or mould according to claim 1, wherein the steel has a stress corrosion cracking resistance with a Kiscc value measured according to ISO 7539-6 standard at room temperature (25° C.) in a 3.5% NaCl solution at pH 6, of 35 MPa*m^{1/2} or more and/or a fracture toughness (Kic value) of 55 MPa*m^{1/2} or more for a yield strength (R0,2 value) of less than 1200 MPa and for a yield strength (R0,2 values) higher than 1200 MPa, the steel has a fracture toughness wherein Kic≥65-0.092*(R0,2-1200) measured according to ASTM E399 at room temperature (25° C.).

8. The tool, die, piece or mould, according to claim 1, comprising a steel having the following composition, all percentages being in weight percent:

| | | | |
|---|---|---|---|
| % Ceq = 0.52-2.48 | % C = 0.52-2.48 | % N = 0-2 | % B = 0-2 |
| % Ni = 0-8 | % V = 0-8 | % Cr = 4.1-29.5 | % Al = 0-18 |
| % Si = 0-8 | % Mn = 8.2-34.6 | % Mo = 0-7 | % W = 0-7 |
| % Ti = 0-8 | % Co = 0-12 | % Sn = 0-2 | % Nb = 0-7 |

The rest consisting of iron and trace elements,
wherein % Ceq=% C+0.86*% N+1.2*% B and
% Ni+% V+% Nb+% Sn+% Si+% Ti+% Co+% W+% Mo=0-9.8.

9. The tool, die, piece or mould, according to claim 1, comprising a steel having the following composition, all percentages being in weight percent:

| | | | |
|---|---|---|---|
| % Ceq = | % C = 0.0001-0.14 | % N = 0-0.1 | % B = 0-0.1 |
| 0.0001-0.14 | | | |
| % Cr = 8-22 | % Ni = 3-14 | % Si = 0-0.89 | % Mn = 0-0.89 |
| % Al = 0-3.8 | % Mo = 0-7 | % W = 0-7 | % Ti = 0-3.8 |
| % Ta = 0-7 | % Zr = 0-7 | % Hf = 0-7 | % V = 0-7 |
| % Nb = 0-7 | % Cu = 0-2 | % Co = 0-6 | |

The rest consisting of iron and trace elements,
wherein % Ceq=% C+0.86*% N+1.2*% B.

10. The tool, die, piece or mould, according to claim 1, comprising a steel having the following composition, all percentages being in weight percent:

| | | | |
|---|---|---|---|
| % C_{eq} = 0.36-2.8 | % C = 0.36-2.8 | % N = 0-2 | % B = 0-2 |
| % Cr = 8-22 | % Ni = 0-14 | % Si = 0-1.4 | % Mn = 0-6 |
| % Al = 0-3.8 | % Mo = 0-7 | % W = 0-7 | % Ti = 0-3.8 |
| % Ta = 0-7 | % Zr = 0-3 | % Hf = 0-3 | % V = 0-7 |
| % Nb = 0-3 | % Cu = 0-4.8 | % Co = 0-6 | |

The rest consisting of iron and trace elements,
wherein % Ceq=% C+0.86*% N+1.2*% B.

11. The tool, die, piece or mould according to claim 1, wherein the tool, die, piece or mould further incorporates electrical heating elements.

12. The tool, die, piece or mould, according to claim 1, wherein the tool, die, piece or mould is manufactured using additive manufacturing.

13. A The tool, die, piece or mould, according to claim 1, wherein at least part of the surface of the tool, die, piece or mould is coated with a thin film.

14. A method comprising use of the tool, die, piece or mould according to claim 1, for hot stamping.

15. The method according to claim 14 comprising the use of the die to drive heat out and/or into desired parts of the die to create soft zones in the stamped component.

16. A method comprising use of the tool, die, piece or mould according to claim 1, for plastic injection.
